(19) United States
(12) Patent Application Publication
(10) Pub. No.: US 2012/0323792 A1
(43) Pub. Date: Dec. 20, 2012

(54) MULTI PLATFORM AND OPERATING SYSTEM DIGITAL CONTENT VENDING, DELIVERY, AND MAINTENANCE SYSTEM

(75) Inventors: Harold L. Peterson, Scotts Valley, CA (US); James B. Williams, Santa Cruz, CA (US)

(73) Assignee: DIGITAL DELIVERY NETWORKS, INC., Scotts Valley, CA (US)

(21) Appl. No.: 13/460,233

(22) Filed: Apr. 30, 2012

Related U.S. Application Data
(63) Continuation-in-part of application No. 13/331,735, filed on Dec. 20, 2011.
Application No. 13/331,735 is a continuation of application No. 09/423,025, filed on Oct. 28, 1999, now Pat. No. 8,126,812.
(60) Provisional application No. 60/058,623, filed on Sep. 11, 1997.

(51) Int. Cl. G06F 21/00; G06Q 30/06

(52) U.S. Cl. 705/51

(57) ABSTRACT

A system to market digital content to a user on an electronics device. A storage media is installed in the device that contains an inventory of assets that are the digital content. Each asset is protected from unauthorized use by a digital wrapper. A logic in the device displays information about the inventory to the user, accepts their selection of a particular asset, transmits a payment for the selection and an identifier associated with it to a clearing house, receives a first key from the clearing house, transmit the first key to a master server, receives a second key from the master server, and unwraps the digital wrapper protecting the asset with the second key.

This is a continuation-in-part of application Ser. No. 13/331,735 filed Dec. 20, 2011; which is a continuation of application Ser. No. 09/423,025, filed Oct. 28, 1999 (now Pat. No. 8,126,812, issued Feb. 28, 2012); which is a National Stage Entry of Int. App. PCT/US98/18948, filed Sep. 11, 1998, which claims benefit of U.S. provisional application Ser. No. 60/058,623, filed Sep. 11, 1997; all now hereby incorporated herein by reference.

This is also related to application Ser. No. 12/437,126 filed May 7, 2009; application Ser. No. 12/416,471 filed Apr. 1, 2009; and application Ser. No. 12/131,834 filed Jun. 2, 2008; all now also hereby incorporated herein by reference; and which all are also continuations-in-part of application Ser. No. 09/423,025, filed Oct. 28, 1999 (now Pat. No. 8,126,812, issued Feb. 28, 2012).

### TECHNICAL FIELD

The present invention relates generally to the marketing functions of vending and delivery of digital content and services related thereto, and more particularly to networked interactive electronics systems for such marketing.

### BACKGROUND ART

We are continuing to see a merging of many products and services into digital formats. Some typical examples of such products are software, for computers and other electronic devices; audio content, like music or audio-books; audio-visual content, like videos and movies; and hybrids that combine these, such as games. For present purposes, the salient feature of such products is that they can often be treated as mere bags-of-bits (BOB's), with the underlying nature of the products ignored during most handling after creation and before use.

Somewhat less widely appreciated is that many services are also becoming digital to a considerable extent. For example, the users of computerized devices today let applets run tests and communicate the results to providers for obtaining installation, upgrade, and problem diagnosis of operating system and applications software; game players send each other hints via e-mail and text messages; Internet “telephone” (e.g., VoIP) and “radio” have emerged as replacements for conventional telephone and broadcast systems; and Internet “video” has opened up whole new channels and genres for marketing, education, amusement, etc. (e.g., YouTube™. Internet “social network” sites integrate and expand on all of this (e.g., Facebook™, Twitter™, LinkedIn™, MySpace™, etc.), as also do Internet collaborative gaming and virtual reality sites (e.g., SecondLife™). Thus, often to a considerable extent, services today are also reduced to digital communications, and can then also be treated as BOB's, in a somewhat more dynamic sense.

For many of the products and services noted above it has long been appreciated that the particular storage medias used have become largely irrelevant. Tape, disk, and drum media all are or once were common, as are physical, magnetic, and optical means of impressing digital content into them. Solid state media are becoming common, and holographic storage remains a close possibility but still one yet to reach the market. Similarly, the channels of communication used have become largely irrelevant. Electrical current through wires, light through fibers, and radiation through space are all common and substantially interchangeable communications channels.

The growing use of communications networks, particularly including public ones like the Internet, are increasing the trend towards the irrelevance of the underlying storage media communications mediums used. Accordingly, in the following discussion the collective term “digital content” is used.

The parent versions of this discussion (circa 1997-99) used examples in the context of personal computers (PCs), noted the relevance to other then common devices such as personal digital assistants (PDAs), and generally reminded the reader that there was applicability to computerized devices in general. Today these examples and this terminology is dated, almost to the extent that younger readers would not recognize the applicability of that discussion to many modern electronics devices. Basically, what has happened in the intervening years is that microprocessors and microcontrollers have become nearly ubiquitous in all electronics devices, to the extent that many older than 35 view “computerized device” and “electronics device” as being synonymous. While conversely, many younger than 35 today view “computerized device” as referring to specialized (non-consumer) hardware or referring to PCs in almost an antique sense. Accordingly, in the following discussion an attempt is made to broaden the use of examples and to use the collective term “electronics devices.” [Indeed, the use of “electronics” here may be unduly limiting, since we may soon see the labels “optical device” and “optronics device” enter the wider vernacular.]

Although a digression, some brief historical discussion may help both older and younger generations understand the use herein of “digital content,” “computerized devices,” and “electronics devices.” Today many users of computerized/electronics devices do not themselves own a PC, and rarely have the desire or need to use one. Generalizing, personal digital assistant (PDA) devices and basic cellular telephones were combined and supplanted by early smart phones. Concurrently, PC-like features were added to many existing and emerging types of electronic devices. For instance, versions of PC operating systems (e.g., Windows™ by Microsoft Corporation of Redmond, Wash.) where adapted and employed in some smart phones. Roughly concurrently, graphical user interfaces (GUIs) and conventional PC components (e.g., magnetic storage “hard drives”) were adapted and employed in television “set-top” boxes. PC-like laptop computers became less common in favor of less PC-like netbook computers, and tablets (many running non-Windows operating systems) are now supplanting both.

Today, but doubtless to also change over time, tablets and smart phones, have become the current “must have” consumer electronics devices. These now can usually handle essentially all of the “traditional” bags-of-bits (BOB) of digital content, such as MP3 and WMA audio, AVI, WMV, and MP4 video and *.txt, *.pdf, *.doc, *.xls, etc. files. Increasingly these are also replacing what PC monitors, laptop screens, and televisions have been used for, either entirely replacing these or else using such as mere “dumb” display units wherein most communications and processing tasks are handled in the tablet or smart phone.

Also changing, at a pace that is hard to keep up with, is what we have traditionally considered television. Subscriber services added considerably to the available broadcast offerings, using the already noted television set-top boxes with cable and satellite feeds. As these devices and services were made sophisticated, non-TV-program-like offerings were added, such as music, games, and play-on-request from media libraries. A recent and ongoing trend has been multi-device access, wherein set top boxes are connected by network technology (e.g., Ethernet and WiFi).

Today televisions and media centers are common that can also be connected by such network technology, and the roles of traditional set-top boxes and the cable and satellite subscriber services are diminishing significantly. Such televisions and media centers today often have circuitry (e.g., Ethernet and/or WiFi) to directly connect to the Internet and to use Internet-based media services, such as web browsing, e-mail, YouTube™, NetFlix™, and Internet radio, gaming, and virtual reality sites. Further, peripheral devices for use with these electronic devices increasingly can provide these capabilities. For instance, some DVD players sold today include Internet connectability and pre-loaded apps to immediately access Internet-based media services. Collectively, the label “entertainment utility device” is used herein to embrace such audio-visual entertainment portal devices.

The prior paragraph introduced “apps,” a term derived from “applications” as used in the traditional PC context. Defining these two terms and drawing distinctions between them is not important or even particularly useful here. But noting the emergence of two relatively distinct terms does serve to illustrate other historical changes that are important. When the parent discussion was written the major operating systems were Windows™ and MAC OS™, and the major hardware was x86-based (from Intel and AMD) or 6800-based (from Motorola Corporation). Today Android™ and Chrome™ are additional major operating systems and the hardware employed is more varied, such as ARM Cortex™ microprocessors.

So what relevance do inventive concepts from pre 1997 have today? Greater relevance, because of our now significantly greater use of digital content and electronics devices. Few of the problems related to these in 1997 have gone away. The hardware handling digital content, and the software employed may have changed considerably, but the underlying challenges remain.

The demands of users to not be burdened by their devices have increased. Users today demand that devices work, immediately and intuitively, with minimal set-up and configuration. Users today also increasingly expect their electronics devices to “inter work,” e.g., to start an e-book at home in an iPad™ tablet and to continue reading it in their iPhone™ during their commute to work, or to purchase a song or movie on their Droid™ smart phone and be able to play it again later on their home entertainment center using a similar GUI (e.g., one in the Android™ operating system).

The present invention address problems that transcend hardware and software, and many of the popular labels used for these. Handling digital content inherently entails tasks that transcend the hardware or software employed. The increased use of, indeed, reliance on digital content has in some ways exacerbated the challenges in addressing the problems, especially across the growing plethora of hardware and software available. In sum, the need for new and improved mechanisms for the marketing, delivery, maintenance of digital content remain and will remain as long as there is change in the digital content industry.

### DISCLOSURE OF INVENTION

Accordingly, it is an object of the present invention to provide a new mechanism for the marketing of digital content.

Briefly, a preferred embodiment of the present invention is a system for marketing digital content to a user on an electronics device. A storage media is installed in the electronics device. This storage media contains an inventory of assets that are instances of the digital content, and each such asset is protected from unauthorized use by a digital wrapper. A logic in the electronics device displays information about the inventory to the user, accepts a selection by the user of a particular asset, transmits a payment for the selection and an identifier associated with the selection to a clearing house, receives a first key from the clearing house, transmits the first key to a master server, receives a second key from the master server, and with the second key unwraps the digital wrapper protecting the selection.

Briefly, another preferred embodiment of the present invention is a unit for use in marketing digital content to a user of an electronics device. A storage media is provided for installation in the electronics device. An inventory of assets are stored in this storage media, where the assets are instances of the digital content and the assets are protected from unauthorized use by a digital wrapper. The storage media further includes a client logic that is installable into the electronics device to display information about the inventory to the user, to accept a selection by the user of a particular asset, to transmit a payment for the selection and an identifier associated with the selection to a clearing house, to receive a first key from the clearing house, to transmit the first key to a master server, to receive a second key from the master server and with the second key to unwrap the digital wrapper protecting the selection.

Briefly, another preferred embodiment of the present invention is a method for marketing digital content on an electronics device. An inventory of assets is stored in a storage media in the electronics device prior to its delivery to a user, wherein the assets are instances of the digital content and they are protected from unauthorized use by a digital wrapper. Information about the inventory is displayed to the user. A selection representing a particular asset is accepted from the user. Money representing payment for the selection and an identifier associated with the selection are transmitted to a clearing house, via a communications system. A first key is receiving from the clearing house and transmitted to a master server, via the communications system. A second key is received from the master server and used to unwrap the digital wrapper protecting the selection.

And briefly, another preferred embodiment of the present invention is a system for marketing digital content in an electronics device. A storage means is provided for storing an inventory of assets which are instances of the digital content, wherein each the asset is protected from unauthorized use by a digital wrapper, and wherein the inventory is stored in the electronics device prior to its delivery to a user. A display means is provided for displaying information to the user of the electronics device. An input means is provided to accept input from the user. A communications means is provided for communicating with remote computer systems on a network. And a client means is also provided. The client means controls the display means to display information about the inventory to the user. The client means also controls the input means to accept from the user a selection representing a particular asset. The client means also controls the communications means to transmit a payment for the selection and an identifier associated with the selection to a clearing house, to receive a first key from the clearing house, to transmit the first key to a master server, and to receive a second key from the master server. And the client means also unwraps the digital wrapper with the second key.

These and other objects and advantages of the present invention will become clear to those skilled in the art in view of the description of the best presently known mode of carrying out the invention and the industrial applicability of the preferred embodiment as described herein and as illustrated in the several figures of the drawings.

### BRIEF DESCRIPTION OF THE DRAWINGS

The purposes and advantages of the present invention will be apparent from the following detailed description in conjunction with the appended drawings in which:

FIGS. 1a-b are basic stylized depictions of how the invention may reside in a users personal computer;

FIGS. 2a-b are basic stylized depictions of the business model used by the invention;

FIG. 3 is a detailed block diagram of a suitable architecture for the invention;

FIG. 4 is a block diagram depicting a functional overview of the invention;

FIG. 5 is a block diagram depicting a navigational overview of portions of the invention which reside in a client electronics device;

FIG. 6 is a depiction of a top view, or “village” view, presented by a graphical user interface (GUI) suitable for use on the client electronics device;

FIG. 7 shows a store GUI view, accessible via the GUI in FIG. 6;

FIG. 8 shows an asset GUI view, accessible via the store view in FIG. 7;

FIG. 9 shows a purchase summary and confirmation GUI view, i.e., a “check-out” view, accessible via either the store view in FIG. 7 or the asset view in FIG. 8;

FIGS. 10a-e show search GUI views accessible via the GUI views in FIG. 6-8, where FIG. 10a depicts an asset name based search, FIG. 10b depicts a provider name based search, FIG. 10c depicts the search of FIG. 10b expanded to include particular assets from a specific provider, FIG. 10d depicts a category based search, and FIG. 10e depicts an overview search based on a village map metaphor;

FIG. 11 is a block diagram depicting a hierarchical overview of an implementation of a master server application using access via the Internet;

FIG. 12 is a block diagram showing a user's first initial view of a local portal in accord a newer embodiment of the present invention;

FIG. 13 is a block diagram showing a view associated with the shop tab in detail, after the user affirmatively selects it or operates a next button while in the view in FIG. 12;

FIG. 14 is a block diagram showing a view associated with the video tab in detail, after the user affirmatively selects it or operates the next button while in the view in FIG. 13;

FIG. 15 is a block diagram showing a view associated with the gadget tab, after the user affirmatively selects it or operates the next button while in the view in FIG. 14;

FIG. 16 is a block diagram showing an initial view of a pillar of the local portal that is arrived at once the user appropriately exits a set-up dialog;

FIG. 17 is a block diagram showing an alternate view of the news pillar subsequent to the view in FIG. 16;

FIG. 18 is a block diagram showing the video pillar in a typical manner;

FIGS. 19a-b are block diagram showing a shop pillar in detail, wherein FIG. 19a depicts representative offerings in a work mode and FIG. 19b depicts representative offerings in a play mode;

FIG. 20 is a block diagram showing the shop pillar once a user selects an offering from the offerings ribbon in FIGS. 19a-b; and

FIG. 21 is a block diagram showing the shop pillar when a large set of offerings may apply, and particularly how search controls may dynamically increase or decrease in number and functionality to adapt to this.

### BEST MODE FOR CARRYING OUT THE INVENTION

A preferred embodiment of the present invention is a digital content vending “machine” (“DCVM”). As illustrated in the various drawings herein, a form of this preferred embodiment of the inventive device is depicted by the general reference character 10.

The DCVM 10 may be advantageously viewed using two analogies. The first of these, which is alluded to by its label, is the vending machine. This analogy serves well for providing a general overview of the invention as a system for vending digital content. The second analogy is a content management service, which manifests as the graphical user interface (GUI) of embodiments of the invention. Two metaphors that have been used in the presentation layers of actual embodiments of the DCVM 10 are described below. The first of these is a village square metaphor and the second is a pillar cover metaphor. The general underlying architecture of both is the same. Neither metaphor should be viewed as limiting, however, and other embodiments of the DCVM 10 can be based on yet other presentation layer metaphors while remaining true to the spirit of the present invention. The village square metaphor was used in early embodiments of the DCVM 10 and, although the inventors have adopted the pillar cover metaphor in their newer embodiments of the DCVM 10, the village square metaphor is still useful as an introduction because it serves particularly well to give an easily grasped and usable perception of the invention as a system for purchasing digital content.

A conventional vending machine, such as a coffee machine, for example, will sell its primary commodity (coffee), but then often also sell parallel market items, like tea and soup, and dispense optional items, like cream and sugar. Similarly, the DCVM 10 sells as its primary commodity digital products, but it also may sell related information and services for such, and also dispense customer support and access to communications with like minded consumers. Thus, the DCVM 10 provides both digital products and digital services, i.e., digital content.

A conventional town center or village square (i.e., a commercial hub, e.g., a shopping mall today) will typically have shops or stores catering to different tastes, income levels, professions, ages, etc. There will be stores that provide primarily goods, and others that provide primarily services. There typically will also be diverting entertainments, and areas set aside simply for communications with those sharing similar interests. And there usually will be directory plaques or information kiosks to help find where things are at and to assist in getting to them. This village square analogy is readily extendable into the DCVM 10, and is now described in detail because it serves particularly well present an easily grasped and usable overview of the invention.

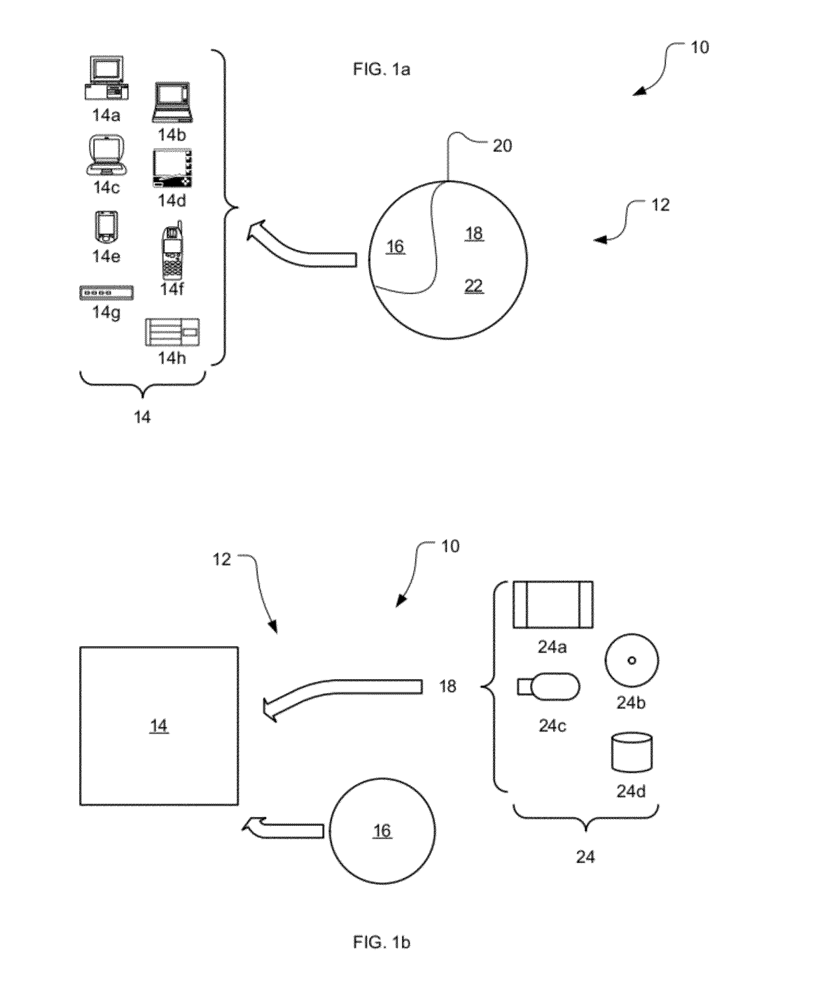

FIGS. 1a-b present how the client 12, i.e., a client application or app, resides on a user's electronics device 14 and contains both an infrastructure 16 and an inventory 18. As stylistically depicted, representative examples of the user's electronics device 14 may be a personal computer (PC 14a), a laptop 14b, netbook 14c, tablet 14d, personal digital assistant (PDA 14e), smart phone 14f, entertainment utility device 14g, or yet other electronic device 14h.

The infrastructure 16 is a software engine that handles the functionality of the DCVM 10, and the inventory 18 is a local collection of assets 22 of merchandise or units of service. The infrastructure 16 is relatively static. Like most software, it perhaps merits an occasional upgrade as new features become available, but otherwise it is generally installed and left alone. Keeping the infrastructure 16 local insures good overall DCVM 10 responsiveness, although in some cases storage on a local area network (LAN) or even a wide area network (WAN) may also be acceptable.

It is anticipated that the infrastructure 16 will usually be stored on a fixed media 20, that is, on a media that is essentially fixed in the electronics device 14. Historically, in the context of PCs 14a, laptops 14b, and netbooks 14c, the fixed media 20 used has been a hard drive. Such magnetic storage drives are now being supplanted by “solid state” drives (typically employing flash memory circuitry to emulate a traditional hard drive). In contrast, in tablets 14d, PDAs 14e, smart phones 14f, and many other electronic devices 14h, fixed static memory is employed without bothering to emulate a traditional hard drive (again, flash memory technology is typically employed, but that is due to price and speed considerations and not any limitations that are particularly relevant here).

In contrast, the inventory 18 is relatively dynamic, potentially including assets 22 such as software products (e.g., applications and apps); images (e.g., cartoons, photographs, maps, etc.); music; video; games; hybrids of these; and anything else which can be reduced to digital format and electronically transmitted and stored. The inventory 18 may be loaded on a local storage device, since storage capacity and transfer rate are more important than responsiveness for the inventory 18. Alternately, the inventory 18 may be made accessible over a LAN or even a WAN having an appropriate bandwidth.

In FIG. 1a both the infrastructure 16 and the inventory 18 are depicted residing together in a fixed media 20 in the electronics device 14 and, as noted in passing already, this fixed media 20 may be essentially any manner of storage media that the electronics device 14 may employ. FIG. 1b depicts a contrasting case, where the infrastructure 16 resides in a fixed media 20 but the inventory 18 instead resides in a removable media 24 which is accessible by the electronics device 14. It follows from the definition of the fixed media 20 that the removable media 24 is one which a user (rather than an OEM or service technician) may “load” (physically or effectively) into their the electronics device 14. Some common current examples of such removable media 24 are secondary hard drives 24a, optical disks 24b, plug-in modules 24c, and yet other removable media 24d. Some examples of secondary hard drives 24a are non-primary storage “drives” (conventional magnetic disk drives and solid state drives) that are user loadable into the electronics device 14 in addition to the primary fixed media 20 that contains the operating system of the electronics device 14. External “drives” that communicate using the universal serial bus (USB) and FireWire™ and eSata™ schemes are current common examples of such secondary hard drives 24a. Some examples of optical disks 24b today are compact discs (CDs), digital versatile discs (DVDs) and BluRay™ discs. And some examples of plug-in modules 24c include the so-called “thumb drives,” mini and micro SD memories, SIM cards, PCMCIA cards, memory sticks, etc.

A key point to be taken here is the distinction between fixed and removable storage media, and not the underlying storage media technology. The spirit of the present invention embraces all potential storage media, including obsolete technologies like mechanical deformations in wax and vinyl discs as well as mechanical, magnetic, and optical impressions in tapes, flexible discs, and drums; and includes “futuristic” technologies like holographic storage.

A sub-class of fixed media 20 is primary fixed media, or simply “primary media.” While an electronics device 14 may have multiple instances of fixed media 20, for instance, two hard drives or both a solid state drive and a hard drive semi-permanently installed, an electronics device 14 has only one instance of primary media installed and usable at any given time. The primary media is the non-volatile storage where at least the operating system (OS), or equivalent, of the electronics device 14 is stored, and loaded from (historically often termed “booted” from) for the electronics device 14 to operate. To facilitate clarity in this disclosure, we use fixed media 20 to mean a storage media installed in an electronics device 14 by a non user (e.g., the original equipment manufacturer (OEM) or a service technician). Where it is important to the discussion that a fixed media 20 is also the primary media that will be made clear.

Continuing, as in real world stores, the inventory 18 of the DCVM 10 needs to be replenished as sales occur, updated as new versions become available, and expanded as suppliers change and new offerings become available. Therefore, the DCVM 10 may be maintained and updated using intelligent push technology over modern networks, like the Internet or cellular telecommunications networks. Such push technology may particularly facilitate providing a one-to-one buying and selling experience for users, and allow individual preferences to be collected and catered to without need of human intervention.

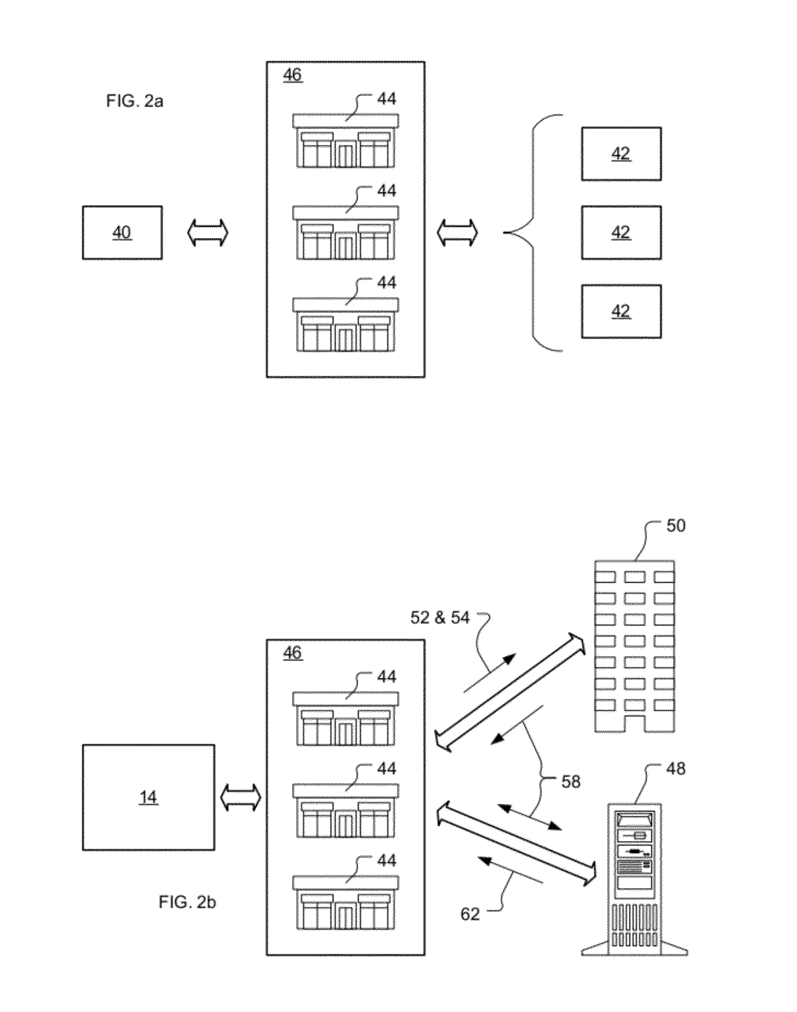

FIG. 2a depicts, in simplified form, a business model usable by the inventive DCVM 10. The end users are termed customers 40 and those entities providing the digital content are termed vendors 42. The vendors 42 operate stores 44 (a term used broadly to denote a point of supply for any digital content, regardless of whether overtly commercial in nature). A graphical user interface (GUI), termed the village 46 here, is used to present collection of the stores 44 as a virtual setting in which the vendors 42 vend and the customers 40 consume. The stores 44 in the village 46 advertise and carry out commerce at various levels of directness, and particularly through several audio and visual channels in each. It is expected that each store 44 typically will feature three main activities: shopping for digital content, viewing events, and communicating.

FIG. 2b depicts a more complete version of this business model. In addition to their local presence, the vendors 42 are also collectively represented on a master server 48, and all can invoke the assistance of a financial intermediary termed a clearing house 50. The clearing house 50 facilitates complex purchase scenarios, permits large numbers of stores 44, and more dynamically provides service to both the customers 40 and the vendors 42.

In a typical example purchase scenario, a customer 40 transmits money 52 and an identifier 54 to the clearing house 50. The clearing house 50 then credits the account of the particular vendor 42, and transmits back to the customer 40 a key 58. Next, usually automatically under control of the infrastructure 16, the customer 40 sends this key 58, or part of it, on to the master server 48, which sends back another key 58 (the keys 58 are typically all unique). Again automatically, if desired, the infrastructure 16 uses this second key 58 to digitally “unwrap” an asset 22 of inventory 18, which has now been “purchased.” Since the money 52, identifier 54, and the keys 58 can all be relatively small, compared to the asset 22 being purchased (typically many megabytes in size), even transactions in very sizable digital content can be carried out quite quickly.

Of course, simpler purchase scenarios are possible. The customer 40 might deal directly and entirely with the master server 48. However, at least for the near future, there is no reason to expect that customers 40 and vendors 42 will feel secure without some “online” commercial intermediary such as the clearing house 50. Alternately, if the asset 22 is already part of the inventory 18, and if the vendor 42 completely trusts the clearing house 50, and if the clearing house 50 is willing to carry appropriate keys 58, the key 58 sent back from the clearing house 50 may be made suitable for directly digitally unwrapping the asset 22. However, since some communications already must take place anyway, and since that will often already be occurring over a medium such as the Internet, there is relatively little burden added by the customer 40 to master server 48 communication legs to the transaction.

The keys 58 play an important security role. They “unlock” a digital wrapper 60 (not shown; but numbered for reference) protecting the asset 22 once it has been paid for. In most cases the vendors 42 will strongly want such protection, to suppress unauthorized copying of their intellectual property. The digital wrapper 60 may use simple serial number entry to enable or disable a reminder feature, or it may use soft or hard encryption (both conventional concepts).

For additional security, in addition even to the use of keys 58, at the option of the vendor 42 (perhaps under a contractual obligation with the actual software publisher), assets 22 may be “machine bound” to one or a limited number of electronics devices 14 or fixed media 20. Indeed, much or the recent development in Digital Rights Management (DRM), employs variations on binding assets 22 to one or more instances of electronics devices 14 in which they can be run, played, viewed, listened to, etc. This can pose additional challenges, but ones that the DCVM 10 can meet. For example, as discussed further below, even verbal delivery of keys 58 to customers 40 via the telephone can be used by the DCVM 10. Such keys 58 obviously must be manageable in size and directly enter-able by the customers 40, yet it is highly desirable by the vendors 42 that the customers 40 not be able to use one key 58 to unwrap more than one copy of an asset 22. This is easily provided for if the keys 58 are each specifically related to some relatively unique indicia of the electronics device 14 or fixed media 20. A Help/About menu access in the village 46 can provide a short code based upon such a unique indicia, and a customer 40 can then enter such a code with a telephone touch pad to receive a key 58 which only unwraps an instance of the particular asset 22 on their electronics device 14 or fixed media 20. In this manner, each asset 22 purchased from the DCVM 10 may be restricted from even highly skilled and determined efforts at unauthorized use.

The keys 58 may also play an important commercial role, facilitating payment and accountability of all parties involved. They may act as customer 40 receipts for payment, and vendor 42 vouchers for payment. Assuming that unique keys 58 are used and are retired after one complete transactional cycle, if the a key 58 is ever lost it can simply be reissued, since it will only work once and then for only its intended purpose. As noted above, use of a second key 58 is optional, but much can be gained by doing so. This permits the vendor 42 to closely track its market, and, more importantly, keeping the vendor 42 in the “loop” permits better customer 40 support. For example, say that a customer 40 starts a purchase scenario for an asset 22 which is in the local inventory 18 in version 4.10, but the master server 48 now has a newer version 4.15 of that asset 22 in stock. Rather than simply return a key for version 4.10, an offer can be communicated to the customer 40 to (1) go ahead and send the key 58 for version 4.10, or (2) transmit version 4.15 of the asset 22 to update the local inventory 18 and also send the key 58 which will unwrap it, or (3) cancel the transaction (perhaps to be resumed after the customer is mailed unit of removable media 24 containing an updated inventory 18).

The master server 48 can also take an active role in maintaining the infrastructure 16 and the inventory 18, by send updates 62 to the electronics device 14 containing fixes and enhancements of the infrastructure 16 and new assets 22 for the local inventory 18. By using the master server 48 as a collector of preferences of the customer 40 to selective apply such updates 62 the inventory 18 can be particularly tailored to the preferences and statistical purchase history of the customer 40.

To assist the master server 48 in this role, customer 40 click (and key stroke) streams can be tracked on the client 12 running on the electronics device 14. This in addition to a substantially unique indicia for the client 12 can then be used with Internet push technology for determining and transmitting appropriately tailored updates 62, or at least prioritizing such updates 62. The indicia used may be a code pre-stored in a fixed media 20 or a removable media 24, or it may be generated on the first execution of the client 12, or it may be provided as a registration process on the master server 48.

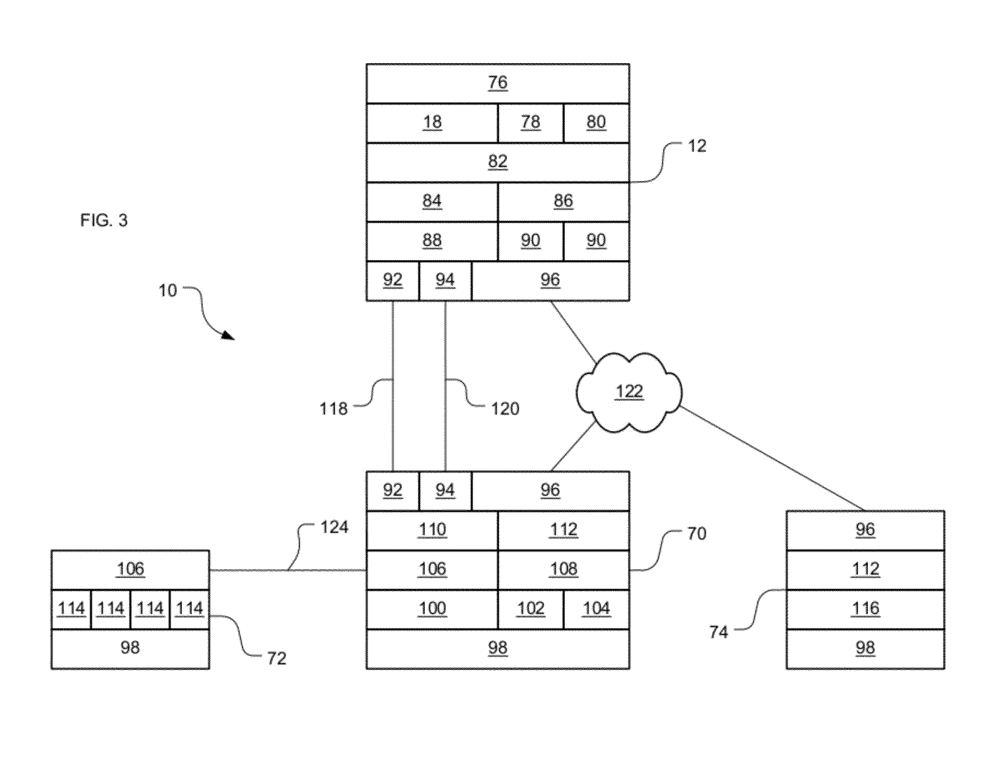

FIG. 3 depicts a suitable architecture for implementing one full featured embodiment of the inventive DCVM 10. The client 12 runs on the electronics device 14 of the customer 40, a master application 70 runs on the master server 48, a clearing house application 72 runs on the clearing house 50, and a streaming media service 74 is provided.

The client 12 resides on the electronics device 14 in a layered structure. The lowest layer is a suitable operating system (a client OS 76; e.g., Windows 7™, Android™, or iOS™). The next layer includes the inventory 18, a village profile 78, and a preference log 80. Atop this is a layer formed by a village manager 82, which using the village profile 78 and preference log 80 permits tailoring for particular customer 40 needs and preferences. At a higher layer are a village interface 84 and an update sub-client 86. Since the village interface 84 itself needs updating from time to time, the update sub-client 86 needs to be in at least as high a layer. Atop this is a layer that includes an order entry interface 88, and client protocols 90 for communications. Finally, within the client 12, is a communications layer which includes a telephone module 92, a private network module 94, and an Internet module 96 for respectively accessing these mediums of communication.

The master application 70 similarly resides in a layered structure on the master server 48. The lowest layer (again hardware and BIOS layers are not shown) is a suitable operating system (a server OS 98; e.g., Windows Server 2008™ or Apache™ server). Atop this are a master interface 100; a profile database 102, from which portions transmitted to a client 12 become stores 44; and a master inventory 104, from which portions transmitted to a client 12 become assets 22 in the inventory 18. The next layer includes a financial peer 106 (discussed further presently) and an update sub-server 108. Atop this is a layer including an order interface 110 and server protocols 112 for use with the Internet (or another network). Finally, within the master application 70, is a communications layer which includes a telephone module 92, a private network module 94, and an Internet module 96.

The clearing house application 72 is run by the clearing house 50, and thus effectively is also a server. It also has as a lowest layer a suitable operating system (another server OS 98). Atop this are financial modules 114, which handle services like anti-fraud, pre-authorization, reporting, etc. And atop this is a financial peer 106, for communicating directly with the equivalent in the master application 70.

The streaming media service 74 has a suitable server OS 98 which supports an audio-visual database 116, atop that server protocols 112, and also an Internet module 96.

The client 12 communicates with the master application 70 via either telephone 118 (touch-pad entry or using voice recognition, and pre-recorded or generated message replies), a private network 120, or the Internet 122. Notably, the first two of these reach customers 40 who are not yet on the Internet 122.

If a telephone 118 is used (say to an 800 or 888 number), the customer 40 may manually enter credit card information on the touch-pad, and then hear recited back a simple key 58 which is used to unwrap the asset 22 purchased (of course, this could also be a conventional verbal human transaction, but such are inefficient). The key 58 may be entered by the customer 40 at the electronics device 14 either as it is received, or it may be written down and used later when the customer 40 is off the telephone 118. If a private network 120 (e.g., a cellular telephone provider's network) is used, the infrastructure 16 may alternately automatically unlock the purchased asset 22, the customer 40 may still note the key 58 (presumably a simple one) for later manual entry. If the Internet 122 is used, the infrastructure 16 can automatically use the key 58 to unwrap the asset 22 now purchased, and the key can accordingly be larger and more complex. It should also be appreciated that groups of customers 40 anywhere on a local network can also use the private network 120 and the Internet 122 variations.

In FIG. 3 the master application 70 and the clearing house application 72 are depicted as connected via a dedicated link 124, i.e., all commercial transactions go physically through the master server 48, but with minimal involvement of the master application 70 itself. This provides for universal access by the client 12 via the master application 70, even over the telephone 118 or private network 120. This also provides for very high security, but that may be dispensed with as alternate security means and confidence in them become widespread, perhaps soon with secured communications over the Internet 122.

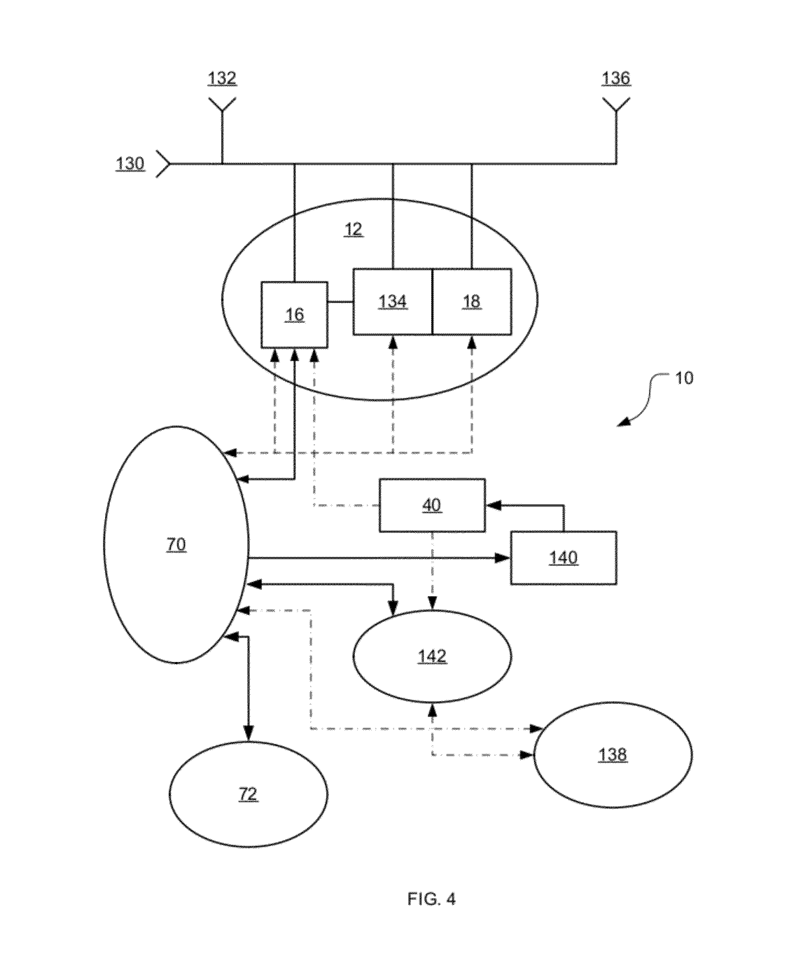

FIG. 4 is a block diagram depicting a functional overview of this embodiment of the inventive DCVM 10. The client 12 is typically installed onto the fixed media 20 of an electronics device 14 by either an original equipment manufacturer (OEM) (step 130) or loaded by a potential customer 40 (step 132) from a removable media 24. The client 12 then contains the infrastructure 16, which provides the GUI of the village 46 to the customer 40, and which is the engine that presents the stores 44 and accesses an inventory database 134 and the inventory 18 itself (either on the fixed media 20 or still on the removable media 24) (an example to consider here is the typical smart phone 14f, which often permits apps to be installed and run from either the fixed media 20 or a loaded removable media 24).

As an aside, the impression may have been conveyed that the stores 44 always reside on the fixed media 20 as part of the infrastructure 16. However, while often desirable, this need not always be the case. Since the DCVM 10 permits the easy addition and deletion of stores 44, and since large number of stores 44 may be provided, general access to particularized sub-sets of the inventory 18 may be accomplished by putting only popular stores 44 onto the fixed media 20, and leaving the rest on the removable media 24. Further, as the customer 40 deletes some stores 44 and as the village 46 accumulates actual usage information, the stores 44 actually on the fixed media 20 can be changed.

For local updating of the client 12 after installation, particularly for updating the sizable inventory database 134 and the inventory 18 (say if it is stored on the fixed media 20), additional removable media 24 may later have their contents copied into the electronics device 14 (step 136). However, this can be reduced considerably, or even eliminated, if a suitable communications means is available.

Once the client 12 is installed, communications with the master application 70 can ensue, directly from the customer 40 through the infrastructure 16 and indirectly from the inventory database 134 and the inventory 18 (as depicted in FIG. 4 in uniformly dashed lines). The master application 70 and the clearing house application 72 are also depicted as able to directly communicate. Further, communications from technical support 138 can pass through the master application 70 to and from the client 12. Since a large percentage of the electronics devices 14 on which the DCVM 10 will be loaded will likely employ step 130 (OEM loading), it is particularly anticipated that this will facilitate access to OEM supplied technical support 138.

The customer 40 can also request fulfillment of orders for hard goods 140 via the client 12. Such hard goods 140 may be ancillary to the inventory 18, e.g., manuals for software assets 22 in the inventory 18, or they may be entirely separate, i.e., permitting the DCVM 10 to optionally be used as a catalog server for entirely non-digital content as well.

However, the customer 40 is not restricted to only communicating via the client 12 to the master application 70. The customer 40 may still use a simple telephone, say using a toll free number, to verbally communicate with phone support 142, and via the phone support 142 to also access the technical support 138 (depicted in FIG. 4 in non-uniformly dashed lines). This particularly facilitates the customer 40 being able to get assistance when the client 12 is “broken” or to advise that something has gone awry in the master application 70.

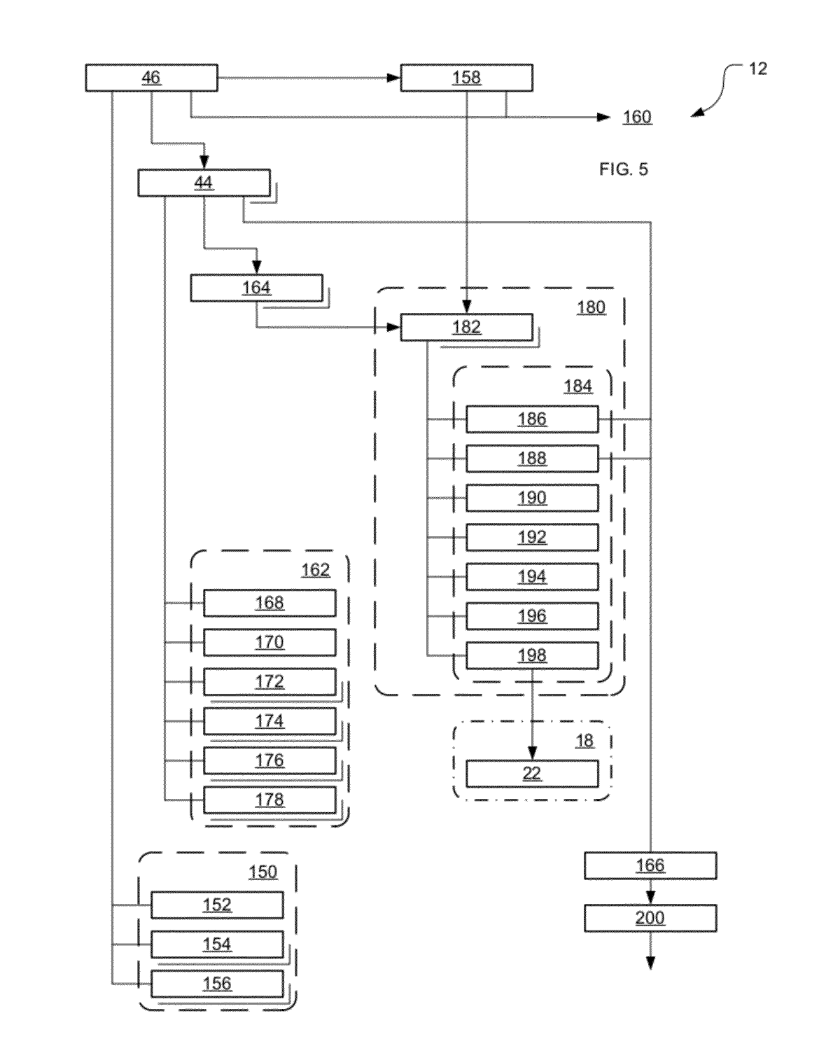

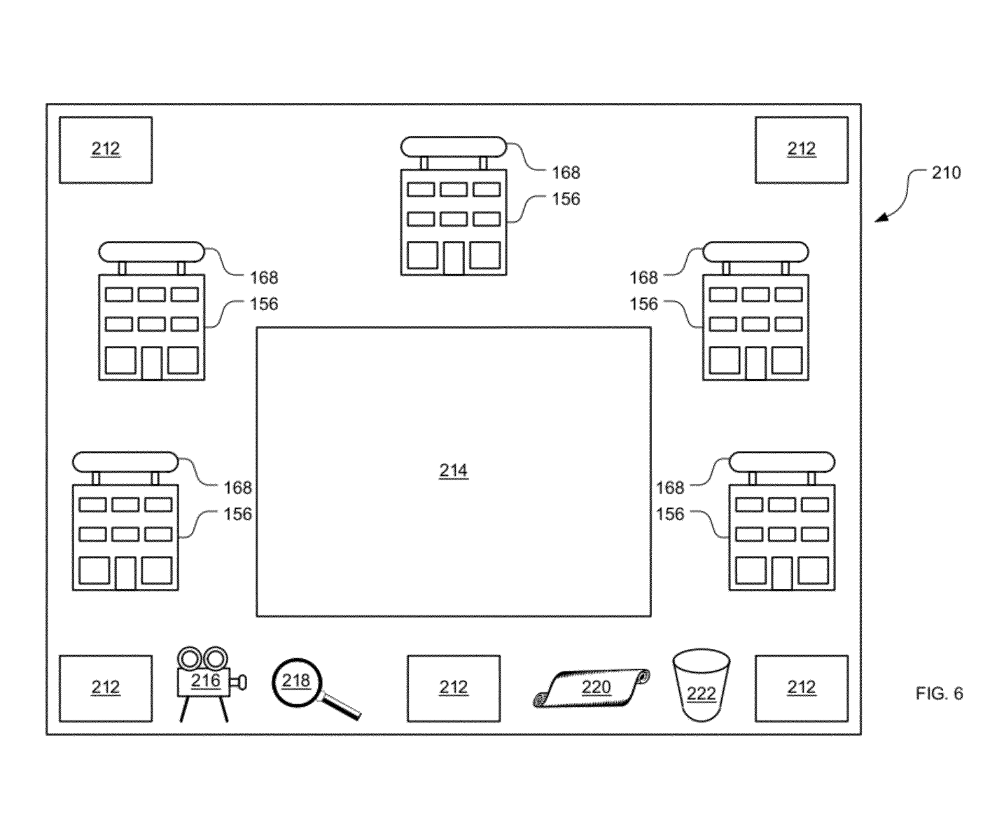

FIG. 5 is a block diagram depicting a navigational overview of the client 12. At the highest level is the village 46, which has a village template 150 including a village video 152, village ad's 154, and a number of store controls 156 (combination button-icons). From the village 46 access is also available to a search feature 158, which provides a quick way to find particular assets 22 (described below), and to an extra assets feature 160 which provides access to digital content not presently in the inventory 18 (i.e., in the master inventory 104 on the master server 48). From the search feature 158 there is also access to this extra assets feature 160. The store controls 156 of the village 46 provide access to the stores 44. Each store 44 has a store template 162, aisles 164, and a shopping cart 166. The store template 162 includes store data 168 (e.g., name, etc.); a store video 170, describing the store 44; and store ad's 172, analogous to traditional end-cap advertisements; optional Internet links 174 for the store 44, i.e., for alternately reaching the sponsoring vendor 42; optional promotional ad's 176, for particular assets 22, i.e., “hot deals”; and aisle controls 178.

The aisle controls 178 provide access to the aisles 164, usually with a plurality appearing for each store 44. Each aisle 164 has an associated aisle template 180.

The aisle templates 180 each include a number of asset controls 182, each in turn associated with an asset template 184. An asset template 184 includes asset data 186 (e.g., name, provider, category, version, etc.), an asset price 188, an asset description 190, an asset video 192, an asset ad 194, a third-party opinion 196 (i.e., a review of the asset 22), and an asset link 198 pointing to where the particular asset 22 is stored in the inventory 18. An asset template 184 may include also include many other sophisticated marketing features, such as a “customers who bought this also bought” or “buy a bundle including this” type functionality, etc.

By appropriate customer 40 selection when viewing an asset template 184 appropriate information, such as the asset price 188 and the asset link 198, are sent to the shopping cart 166, a place where information identifying prospective asset 22 purchases accumulates prior to formal purchase. Later, back at the store 44 level, the customer 40 can then access the shopping cart 166 and invoke an order module 200 to selectively complete formal purchase of chosen assets 22 in the shopping cart 166.

FIG. 6 depicts a suitable village view 210 for presentation to the customer 40, say, on the screen of a PC 14a, laptop 14b, netbook 14c, tablet 14d, or entertainment utility device 14g. [Smaller devices, for instance handheld ones, can use a simplified version of this, but may more easily use pillar based presentations, described in detail presently.] A series of ad cells 212 are placed about the village view 210. These may contain either fixed or banner advertisements from the village ad's 154. The major features of the village view 210 are the store controls 156, each with respective store data 168 prominently displayed, and a centrally placed video display 214. Further provided, at the bottom of the village view 210, are a video control 216, to start/restart the village video 152 in the video display 214; a search control 218, which invokes features described below; a guarantee control 220, which invokes display in the video display 214 of business information about the parties operating the master application 70, the clearing house application 72, and the respective vendors 42; and a delete village control 222, to entirely eliminate the DCVM 10 from the electronics device 14.

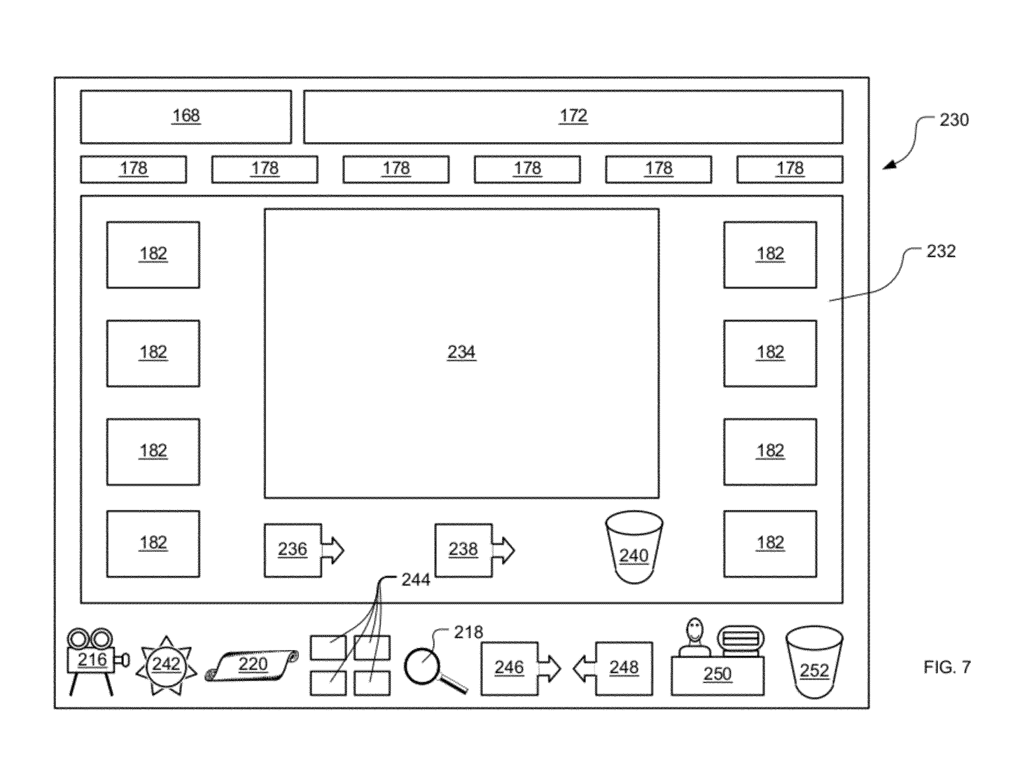

FIG. 7 depicts a suitable store view 230 for presentation to the customer 40. The store data 168 (at least the store name) and the store ad 172 are displayed at the top. Below is a row containing the aisle controls 178. And below that row is an aisle sub-view 232, which changes depending upon which aisle control 178 is currently selected. The aisle sub-view 232 includes a video display 234, asset controls 182, an aisle update control 236, a next page control 238 (to display a subsequent view of assets, since aisles may often contain more than will fit on one view), and a delete aisle control 240. At the bottom of the store view 230 are the video control 216, to here start/restart playback of the store video 170; a promo control 242, to start/restart playback of the promotional ad's 176; the guarantee control 220; a links control 244, to display the Internet links 174 for the store 44; the search control 218; an update store control 246; a return to village control 248, to return to the village view 210; a checkout control 250; and a delete store control 252, to remove the present store 44 from the client 12.

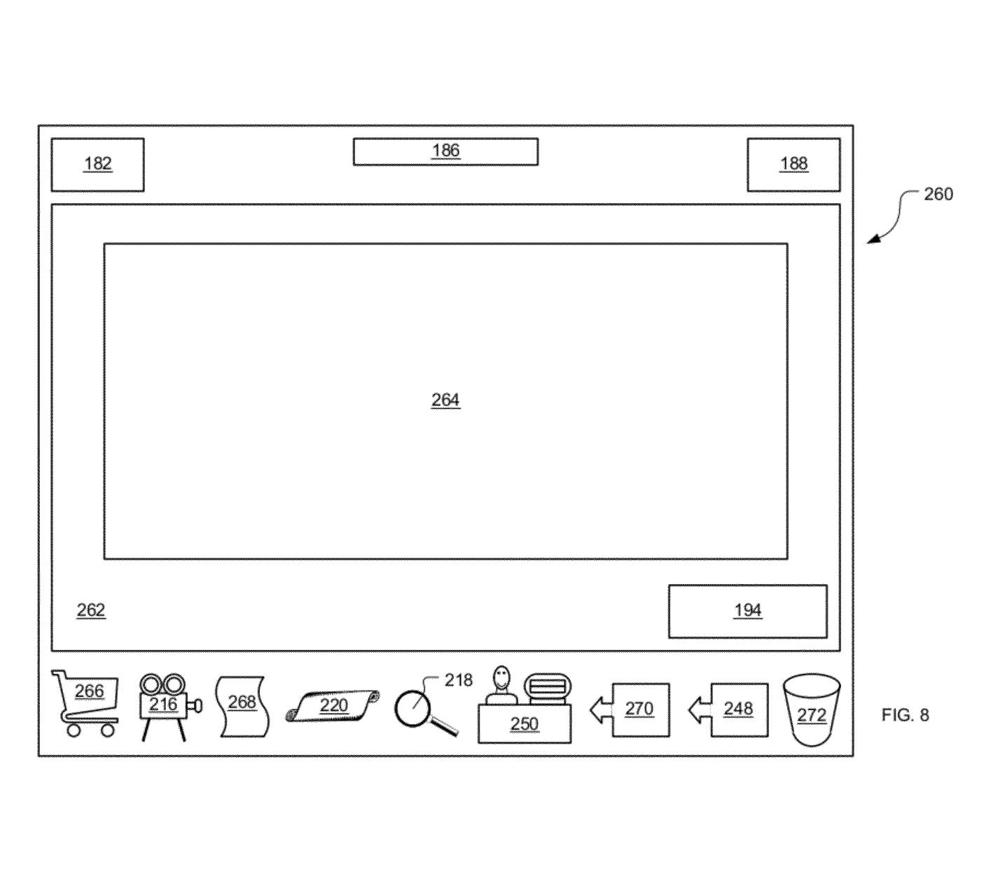

FIG. 8 depicts a suitable asset view 260 for presentation to the customer 40. Displayed at the top are the asset control 182 (here acting only as an icon, since it cannot be selected to go to another view), the asset data 186 (at least the asset name), and the asset price 188. Below is an asset sub-view 262 which includes an asset display 264 and the asset ad 194 (typically a banner type ad that “rotates” continuously).

At the bottom of the asset view 260 are a shopping cart control 266 (to add the present asset to the shopping cart 166), the video control 216, an opinion control 268, the guarantee control 220, the search control 218, the checkout control 250, a return to store control 270, the return to village control 248, and a delete asset control 272.

Depending upon operation by the customer 40, the asset display 264 presents either the asset description 190 (the default), the asset video 192, the third-party opinion 196, or guarantee information.

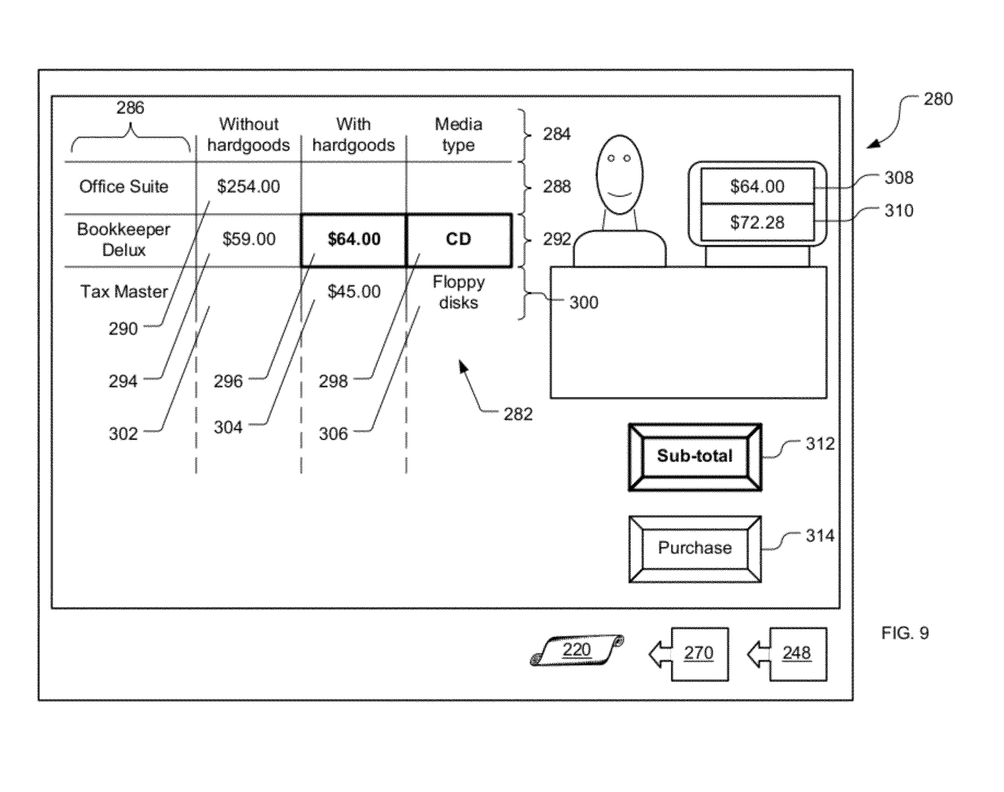

FIG. 9 depicts a suitable checkout view 280 for presentation to the customer 40. Included is an asset table 282 which displays information about all of the assets 22 presently in the shopping cart 166. Across the top of the asset table 282 are column headings 284, indicating availability options, e.g., “without hardgoods,” “with hardgoods,” and “media type.” Along the left side of the asset table 282 are row headings 286 containing respective asset names (from the asset data 186). Depending upon which columns they are in, the cells of the asset table 282 contain asset prices 188 or availability options, and in some cases also function as controls.

For example, assuming the availability options listed above in the asset table 282 presented in FIG. 9, the topmost row 288 contains data only in cell 290 (the leftmost). Further, cell 290 contains an asset price 188 which is not highlighted (in FIG. 9 heavy cell outline designates highlighting). This situation depicts that the asset 22 in row 288 is only available without hardgoods, and that the customer 40 has not yet selected this cell to confirm that they do want to purchase this.

The middle row 292 in this example contains asset prices 188 both in cell 294 and in cell 296, and cell 298 is highlighted and contains text describing a media type. This situation depicts that the asset 22 in row 292 is available both with and without hardgoods, at the respective prices, and that the “with hardgoods” option has already been selected by the customer 40 (as indicated by the highlighting of cell 296 rather than cell 294). The customer 40 here may chose among multiple media types (as indicated by the presence of highlighting in cell 298). Further, since cell 298 is highlighted, the customer 40 may operate it as a control, say with a mouse double-click, to cycle between the available media type choices.

The bottom row 300 in this example contains nothing in cell 302, designating that this asset 22 always comes with hardgoods (say a manual); a price in cell 304 (un-highlighted, and thus as yet un-selected); and un-highlighted text in cell 306. The absence of highlighting for a media type indicates that no choice is available, so the customer 40 should be particularly sure that they can use the media type being noted.

Also appearing in the checkout view 280 are a sub-total box 308, a grand total box 310, a sub-total control 312, and a purchase control 314. The sub-total box 308 displays a running total of the asset prices 188 for selected assets 22 in the asset table 282 (note that only one of the three displayed assets 22 is actually selected in the example, so only its price is used in the sub-total). By activating the sub-total control 312 the customer 40 requests display in the grand total box 310 of the amount in the sub-total box 308 plus applicable shipping costs and taxes (here the sub-total plus 8.25% tax and $3.00 shipping and handling). Activating the purchase control 314 formally requests that purchase take place.

Across the bottom of the checkout view 280 are the guarantee control 220, the return to store control 270, and the return to village control 248.

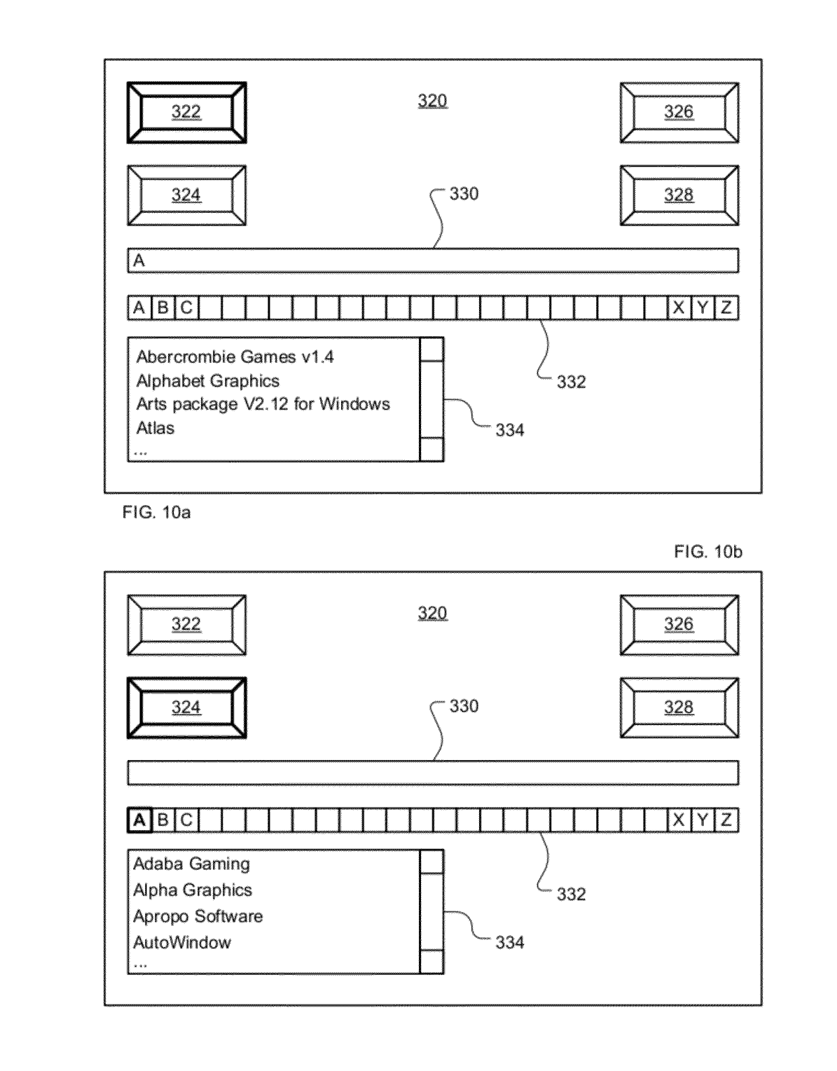

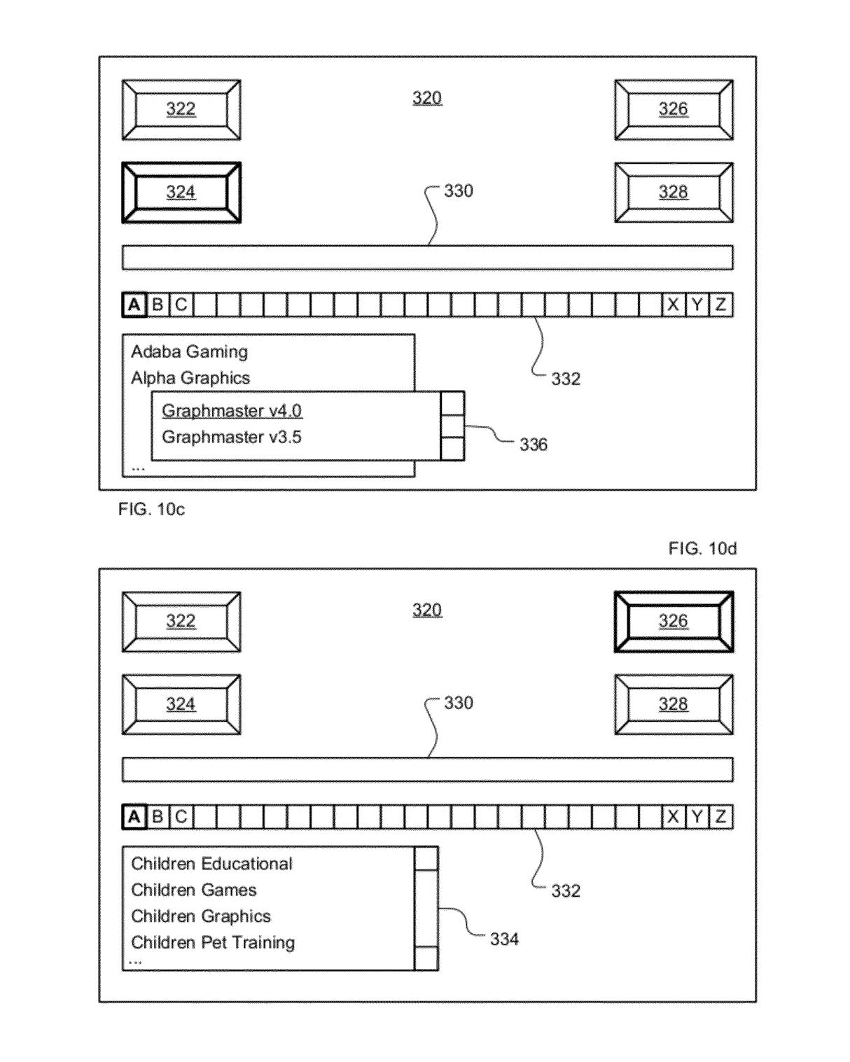

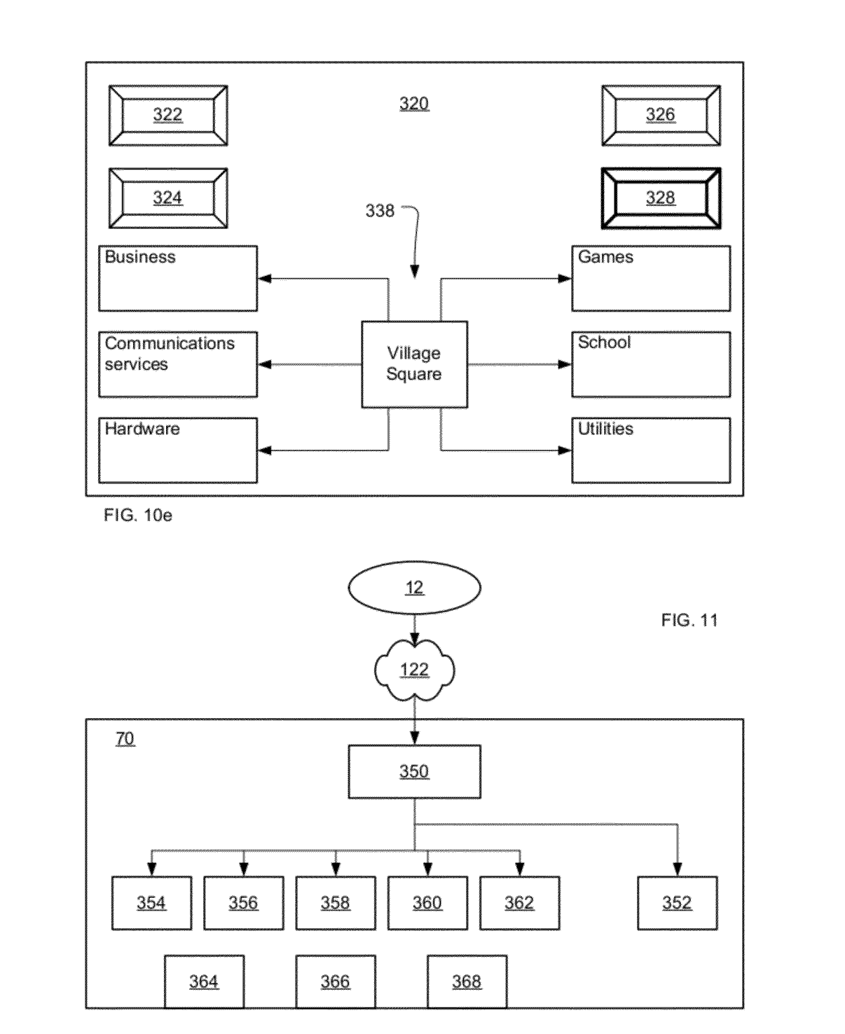

FIG. 10a-e are stylized depictions of the information presented to the customer 40 when the search control 218 is selected. A search view 320 then appears which includes an asset control 322, a provider control 324, a category control 326, a map control 328, a text entry box 330, a character selection array 332, and a list box 334. In some cases the list box 334 can further include a sub-list 336 (FIG. 10c), and in one case the text entry box 330, the character selection array 332, and the list box 334 may all be replaced with a map sub-view 338 (FIG. 10e).

FIG. 10a shows the default of a search view 320, i.e., a view first seen by the customer 40. The asset control 322 is highlighted (shown with a heavy lining in the figure) to confirm to the customer 40 that the asset based variation of the search view 320 is currently active. The customer 40 may select a provider control 324, a category control 326, or a map control 328 to use other variations of the search view 320. Or, if they have already done so, selecting the asset control 322 will return them to the variation of FIG. 10a.

In the asset based search view 320 of FIG. 10a, the customer 40 may either type initial letters of the asset name (as it appears in the asset data 186) into the text entry box 330 (as depicted in FIG. 10a), or mouse click a first letter in the character selection array 332. These operations scroll the list box 334, which in this variation displays names for assets 22. Alternately, the customer 40 can directly scroll the list box 334. By appropriate choice, perhaps as a setup option, selection of a particular entry in the list box 334 cause an associated asset 22 to be added to the shopping cart 166, or this can take the customer 40 to the asset view 260, with the selected asset 22 there displayed.

If the customer 40 selects the provider control 324 the search view 320 changes to the variation shown in FIG. 10b. Again letters can be entered in the text entry box 330 or mouse clicking may be used to select a first letter in the character selection array 332 to scroll the list box 334 (the case depicted in FIG. 10b), but now provider names are instead displayed for assets 22 in both the inventory 18 (the names as recorded in the asset data 186) and also the master inventory 104.

FIG. 10c shows how selection of a particular provider name in the list box 334 can then cause further display of a sub-list 336 to show assets 22 available from the selected provider. Highlighting, underlining (used in FIG. 10c), or some other convention may be used to distinguish which assets 22 are present locally in the inventory 18, and which are in the master inventory 104. As discussed for FIG. 10a, above, selection of a particular asset entry can be configured to take the user to the asset view 260 or add the selection to the shopping cart 166.

If the customer 40 selects the category control 326 the search view 320 changes to the variation shown in FIG. 10d. Again letters can be entered in the text entry box 330 or mouse clicking may select a letter in the character selection array 332 (the case depicted in FIG. 10d) to scroll the list box 334, but now it instead displays categories of assets 22 in both the inventory 18 and also the master inventory 104. Selection of a particular entry in the list box 334 presents the sub-list 336, only now containing assets by category, and moving to the asset view 260 or addition to the shopping cart 166 can proceed.

In keeping with the village 46 analogy, a map variation of the search view 320 may also be invoked, by selecting the map control 328. This variation is depicted in FIG. 10e, which has the text entry box 330, the character selection array 332, and the list box 334 all replaced with a map sub-view 338. The map sub-view 338 presents a graphic somewhat resembling a conventional map, but since geographic location need not be represented, what is instead displayed are general categories presented as regions encompassing related sub-categories. Here selecting a category or subcategory takes the customer 40 to an appropriate other view.

The DCVM 10 is a media rich, and convenient consumer shopping experience. Delays are eliminated by pre-positioning all or at least substantial portions of the “store,” its inventory of assets, and collateral marketing materials at the customer's electronics device 14.

As has been described, the user interface the DCVM 10 may be based on the metaphor of a small village, which consists of some number of shops, each of which contains some number of aisles, and each aisle contains some number of digital content items. Recall also that the digital content includes either or both of goods and units of service.

The inventory of digital content, advertising, and other information related to the digital content can be updated on a regular basis, both from removable media 24 and via network based synchronization and “push” techniques (e.g., via the Internet).

A valuable aspect of the DCVM 10 is its ability to track customer browsing behavior, purchases, and information requests along with what parts of the store are deleted or reconfigured by the customer. By compiling a customer profile and knowing the customer's preferences the most useful information and assistance about the digital content can be provided to the customer. The DCVM 10 can then particularly pre-position advertising and inventory on the consumer's electronics device 14, along with a convenient purchasing capability. This particularly permits many business models for use with newly acquired electronics devices 14.

For example, the customers of such models may include: end users, OEM and system integrators, independent vendors (IVs) of software and multimedia content, and advertisers. The end users benefit because as consumers they gain high performance, and a convenient and compelling shopping experience for both pre-positioned digital content and remote hard-goods (typically, but not necessarily, related to the pre-positioned digital content). The consumer enjoys a focused inventory selection and, for pre-positioned digital content, a highly convenient and nearly instantaneous purchase process regardless of the size of an item. The OEMs and system integrators gain an annuity-style revenue stream by hosting the DCVM 10 on newly built electronics devices 14. The IVs gain access to significantly increased visibility, particularly during the “peak buy period” for a newly acquired electronics device 14, with virtually no distribution cost or hassle. And the advertisers have a new platform for advertising that has two key values: an upscale directed client base, and detailed data on the end users who see the advertising. The advertiser can have a number of options, including a full store presence, banner advertisements, etc. The types of advertisers may include intellectual property providers (IPPs), hardware system and accessory providers, and Internet service providers, among others.

The services provided by such business models may include: hard goods fulfillment, clearing house services, and direct system provider services. For hard goods fulfillment the DCVM 10 is uniquely positioned to provide a convenient shopping access to hardgoods fulfilled through traditional means, contemporaneous with its online digital content vending role. The DCVM 10 is also able to provide for necessary commercial clearing house functions, say, by means of a strategic partnership with one or more clearing house providers. As direct system provider services, the DCVM 10 can provide: customer turnkey business solutions for OEMs and system integrators; management of collateral and the digital content inventory (to collect, organize, integrate, package, test, etc.); maintenance of the infrastructure or “stores”; golden master production for loading the media delivery system; collections and billing; as well as be a provider of utilization and advertising demographics data.

The initial versions of the DCVM 10 were targeted at home users and small office/home office (SOHO) users. Small business, corporate and enterprise markets were then additionally targeted with focused features and appropriate methods of communicating in subsequent releases. These proved successful and later versions of the DCVM 10 have followed this model.

As described so far herein, the village or “mall” shopping metaphor based version of the DCVM 10 has principally been used for the sake of example. Within this village metaphor a user interface provides for: browsing and navigation, search, and purchase. A combination of a browser interface and integrated application can be provided for update control, purchase management, and configuration control. The end-user customers can then use a web browser-like application or app to shop, browse, navigate, and initiate purchase through the DCVM 10 of its contained or associated digital content.

The stores 44 of the DCVM 10 include digital content from two sources: pre-positioned digital content (in the inventory 18 already at the client 12; see e.g., FIG. 1a) and extended or master inventory 104 located in online extensions or on a content server (e.g., the master server 48 of FIGS. 2b and 3).

The DCVM 10 may make a compelling presentation, particularly including high performance access to content allowing greater use of high-resolution materials. This particularly facilitates easy navigation to find digital content, easy searching, applications or apps which are intuitive and browser-based, and seamless continuity with online extensions of the DCVM 10.

“Shopping Cart” and “Checkout” metaphors may be used for both off and on line purchasing. FIGS. 6-9 generally illustrate this. Checkout may be accomplished via an online connection (say, to a Distributed Transaction Server). But alternate purchase options are also possible, such as providing human operator supported telephone support, purchase support for standard credit cards, and purchase support for “credits” for “freegoods,” as may be required or desired by some partner OEMs.

Softgoods fulfillment may be accomplished by “unwrapping” pre-positioned intellectual property and by providing means for additional download of intellectual property (and subsequent unwrap, decrypt, enable, key entry, etc).

Hardgoods fulfillment may be accomplished via forwarding purchase requests directly to hardgoods fulfillment houses and indirectly through clearing house arrangements for EDI based fulfillment.

As described further herein, the client 12 based store of the DCVM 10 may be updated through online push channels and through distribution of removable media 24 (FIG. 1b). Digital content assets 22, collateral materials, look and feel elements (all treatable generally as digital content) as well as the infrastructure engine, are all candidates for update in this manner. Updates to a client 12 may be prioritized based on design specified requirements and user set policy. Prices and easy, small updates typically will be updated most frequently, but permission to update can be set by client policy. Easy transition between “browsing” and “update” modes can also be provided so that users will control and manage updates by policy and by category. Concurrent with this, the user's behavior (i.e., that of the customers 40) can be tracked and profiled, and this in turn facilitates updating and ensuring that user set policy is met.

The customers 40 may be provided with a content manager as part of the infrastructure 16, to control and manage aspects of the DCVM 10. The entire village 46 may be removed under user control, for instance, or new stores 44, aisles 164, and digital content assets 22 may be added to the existing local stores 44 in order to expand or to get better performance in a particular area, or simply removed in order to reclaim storage space at the client 12.

The customers 40 may therefore set policy for actions in various areas. For example, they may update policy, e.g., specify to always warn, ask, or never warn. They may set connection policy, e.g., to anytime/automatic, ask, never. They may define privacy policy, e.g., to tell all, to say nothing, or somewhere in between.

Identification of the customers 40 and OEM sourced units of the electronics devices 14 can be established and maintained through on-line, voice, and mail registration. The customers 40 can be encouraged to provide additional profiling information through awards and granted digital certificates. Award and “freebie” activities can also be coordinated with the individual OEMs. The activity of the customers 40 in the stores 44 can be tracked, and uploaded as profile information ultimately to be stored in a customer information server. Of course, a privacy policy can be established and maintained within the conventions of Internet shopping.

Some particularly customizable components of embodiments of the DCVM 10 can be sponsorship and advertising graphics. In addition, identifying information can be embedded into each OEM associated client 12, such that purchases and activities associated with a particular release of the DCVM 10 can be tracked. (Enabling OEM associated tracking of transactions.)

The DCVM 10 can provide customer service through a variety of outlets, and services. Arrangements can be made with OEMs for direct support of particular OEM's goods. Goods sold through other arrangements, say, with hardgoods manufacturers, can also be supported directly by the manufacturer.

The DCVM 10 can provide direct customer service for order management and fulfillment, payment, first line digital content installation issues and for technical support questions and problems. These services can be provided through a web support site, chat, text messaging, or by fax or e-mail.

As noted in the Background Art section, early embodiments of the DCVM 10 were directed at PCs 14a and similar electronics devices 14 that used hard drives. But a PC is just one type of electronic device or system and a hard drive is just one type of primary storage unit. Those skilled in the relevant arts will readily recognize that the present invention can be used to initially provide and maintain, offer and vend, deliver or enable, configure and service digital content in a wide range of primary storage units in electronics systems (and potentially in small and enterprise networks as well). The examples noted, without limitation, in the Background Art section bear some additional consideration in view of this. Gaming stations, like Sony's Playstation™ and Microsoft's X-Box™ have a hard drive which can be pre-loaded with digitally wrapped game software, clue books, advertising, etc. The user can then view or use this, or may obtain a key to promptly access and be able to use such. The same process works well for personal communication service (PCS) devices, television “set-top” boxes like WebTV™, thus being some additional examples of entertainment utility devices 14g and suitable other electronic devices 14h.

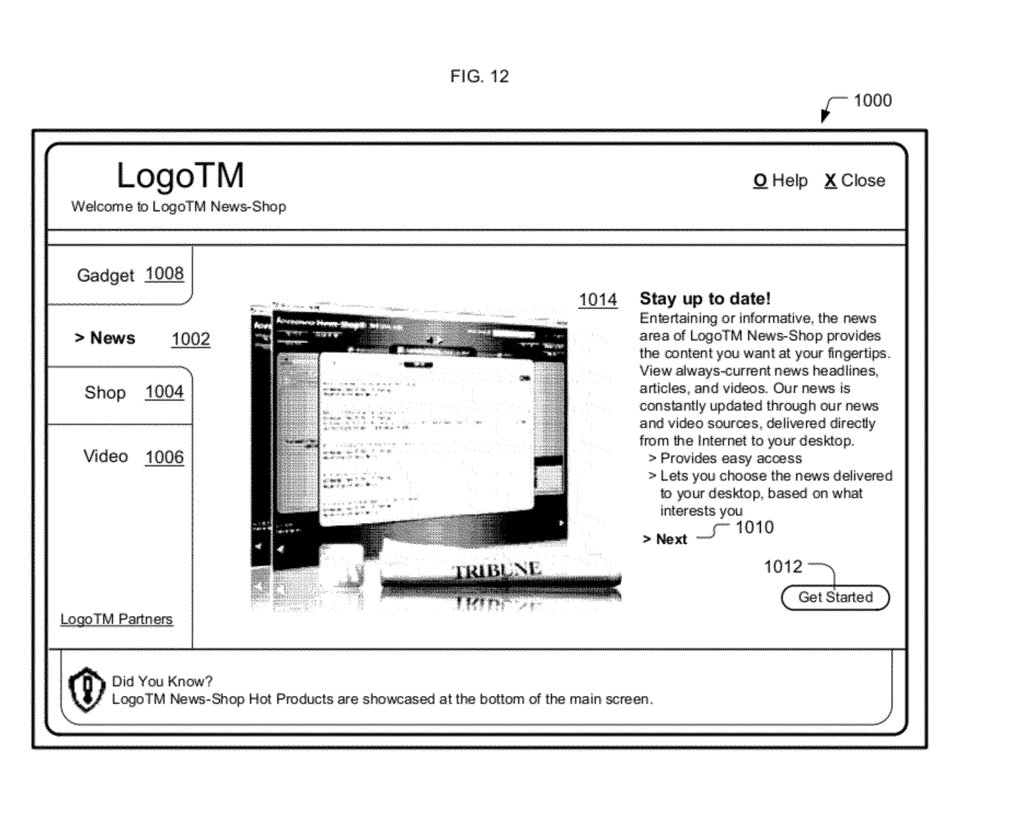

Turning now to an exemplary embodiment that follows the inventors' more recent pillar cover metaphor, the following describes such an embodiment of the DCVM 10 that may serve as a local portal 1000. FIG. 12 is a block diagram showing a user's first initial view of a local portal 1000 in accord with this. The local portal 1000 here displays a news tab 1002, a shop tab 1004, a video tab 1006, and a gadget tab 1008. FIG. 12 shows the news tab 1002 in detail, which typically appears first and then may be navigated away from. In particular, the news tab 1002 includes a next button 1010, a get started button 1012, and introductory information 1014.

The local portal 1000 is particularly an example of an embodiment of the DCVM 10 that can be tailored to a wide variety of hardware. For the sake of example, the figures here show the local portal 1000 on a larger display, as might be found on a PC 14a, laptop 14b, netbook 14c, tablet 14d, or television screen used with an entertainment utility device 14g. In straightforward manner, however, the local portal 1000 can be adapted to also be used on a PDA 14e, smart phone 14f, and handheld or other small electronics device 14.

Embodiments of the local portal 1000 can employ sophistication for this far beyond merely designing the embodiment to display more or less to the user at once. With modern tools (e.g., Java™ and other largely hardware agnostic programming languages) and an investment in the appropriate skills to use these tools, the present inventors are creating embodiments of the DCVM 10 with increasingly “smart” capabilities that allow it to automatically sense not only its operating system environment, but also the type of electronics device 14 upon which it resides.

One approach here is to sense the operating system of the electronics device 14 on which the client 12 of the DCVM 10 is being installed, and to install the correct, compatible version of the client 12, linked to a common backend server architecture. Another approach here is employ maximum hardware agnostic programming to run a common client 12 that includes a set of specific drivers and that dynamically selects and employs the currently appropriate one. With this latter approach aspects of the inventive DCVM 10 can even be made partially “cloud based,” wherein the relatively small infrastructure 16 is accessed in its most current form (for the currently being employed electronics device 14) over a ubiquitous network (e.g., the Internet 122) and run locally. In this manner the advantages of having local assets 22 in the inventory 18 can still be realized (e.g., no wait for delivery, configured for or tied to the electronics device 14, etc.).

Based on programmed in intelligence, the DCVM 10 (e.g., the local portal 1000) can operate seamlessly across multiple electronics devices 14 (e.g., PC 14a, tablet 14d, handheld smart phone 14f, or wall-size TVs used with an entertainment utility device 14g). Common information about the user can be used across all of the applicable hardware platforms, to thereby provide the same experience to the user regardless of the device or location they currently employ.

The present inventors have termed the concept employed here “SAGE,” for Smart Adaptable General Ecosystem. SAGE describes how the DCVM 10 is expanded across multiple platforms and multiple operating systems, and has the intelligence to recognize its environment and adapt. SAGE also has the ability to drive the same experience for multiple users across multiple devices, for instance, with a single user ID being usable across multiple electronics devices 14 to dramatically simplify the user's ability to receive the same experience regardless of the specific electronics device 14 they are currently using.

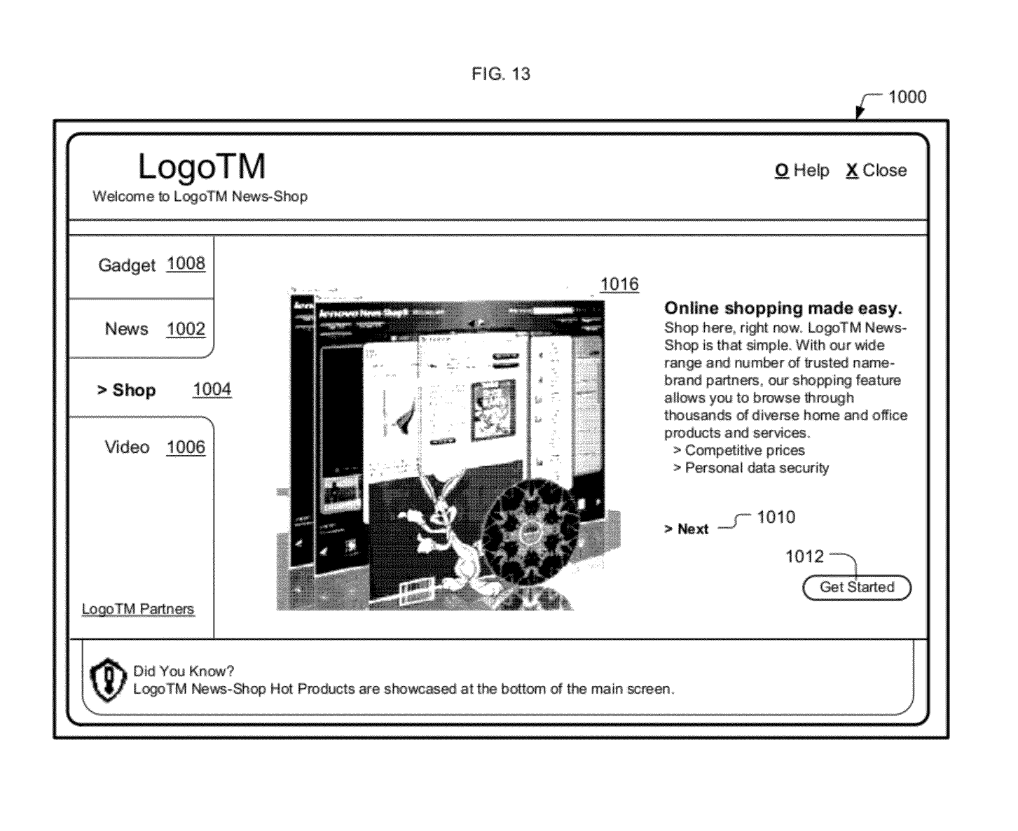

FIG. 13 is a block diagram showing a view associated with the shop tab 1004 in detail, after the user affirmatively selects it or operates the next button 1010 while in the view associated with the news tab 1002. As can be seen, a different set of introductory information 1016 is now provided, along with the next button 1010 and the get started button 1012.

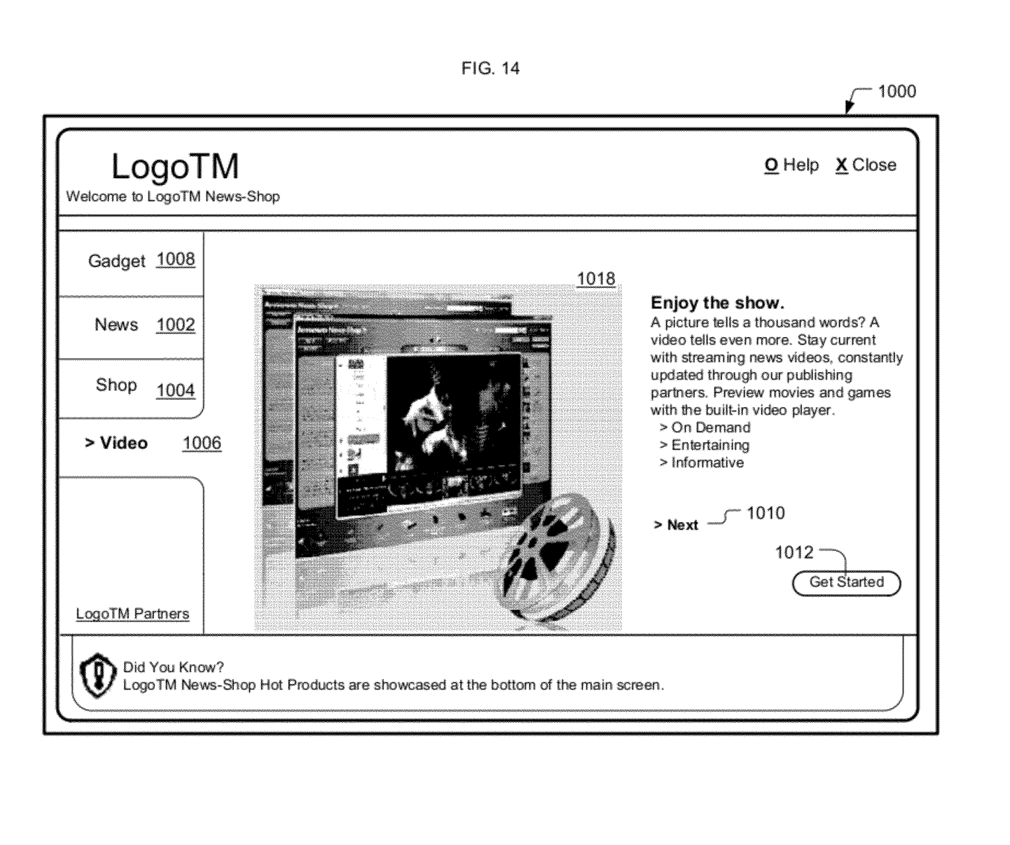

FIG. 14 is a block diagram showing a view associated with the video tab 1006 in detail, after the user affirmatively selects it or operates the next button 1010 while in the view associated with the shop tab 1004. As can be seen now, a different set of introductory information 1018 is now provided, again along with the next button 1010 and the get started button 1012.

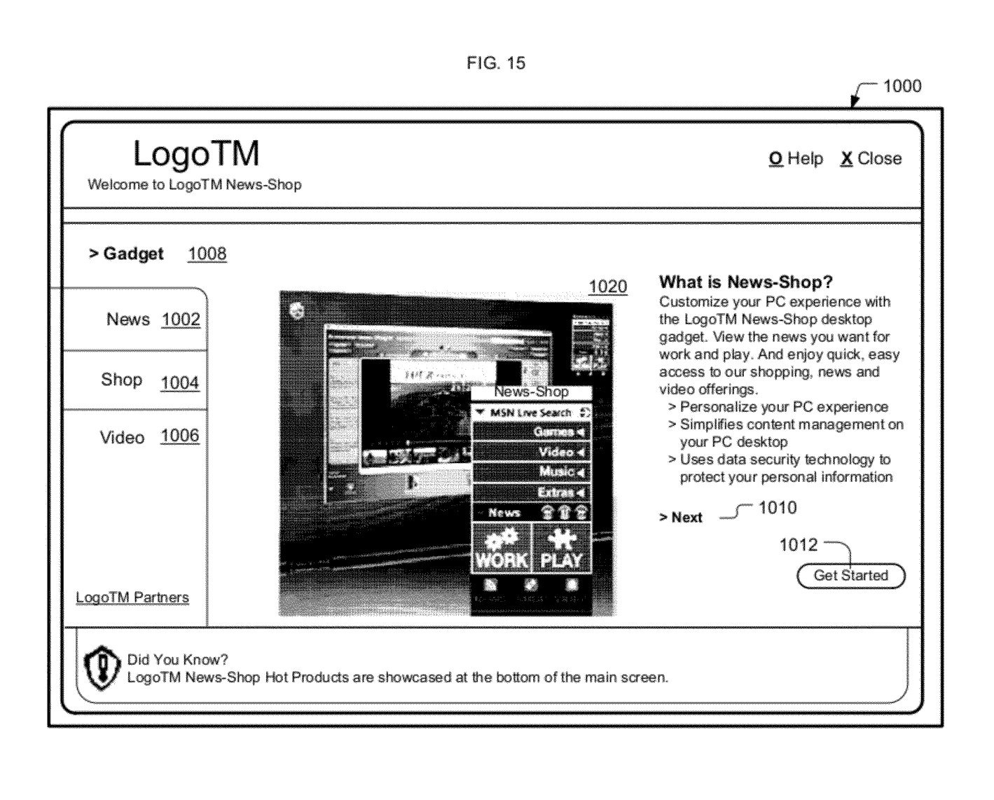

FIG. 15 is a block diagram showing a view associated with the gadget tab 1008, after the user affirmatively selects it or operates the next button 1010 while in the view associated with the video tab 1006. A different set of introductory information 1020 is now provided, with the next button 1010 and the get started button 1012.

Summarizing, here the local portal 1000 starts in the view associated with the news tab 1002, with “news” being one of the three pillars of this embodiment of the DCVM 10. As a matter of design, the user interface of the local portal 1000 here revolves around a number of pillars and this aspect is discussed as its features are introduced in the following.

Collectively, FIGS. 12-14 take a new user through a quick and simple introduction. And FIG. 15 introduces the new user to a powerful, but optional, tool that can be used with the local portal 1000. To go any further with this embodiment of the local portal 1000, however, a new user should operate the get started button 1012 to set up the DCVM 10 by entering user and account information. In keeping with the ability of modern electronics devices 14 to have multiple user accounts, with one or more for each user, the local portal 1000 can similarly permits multiple user accounts, and at least one should usually be set up before the local portal 1000 is used. The dialogs used for this can require more, less, or different information as a matter of design choice.

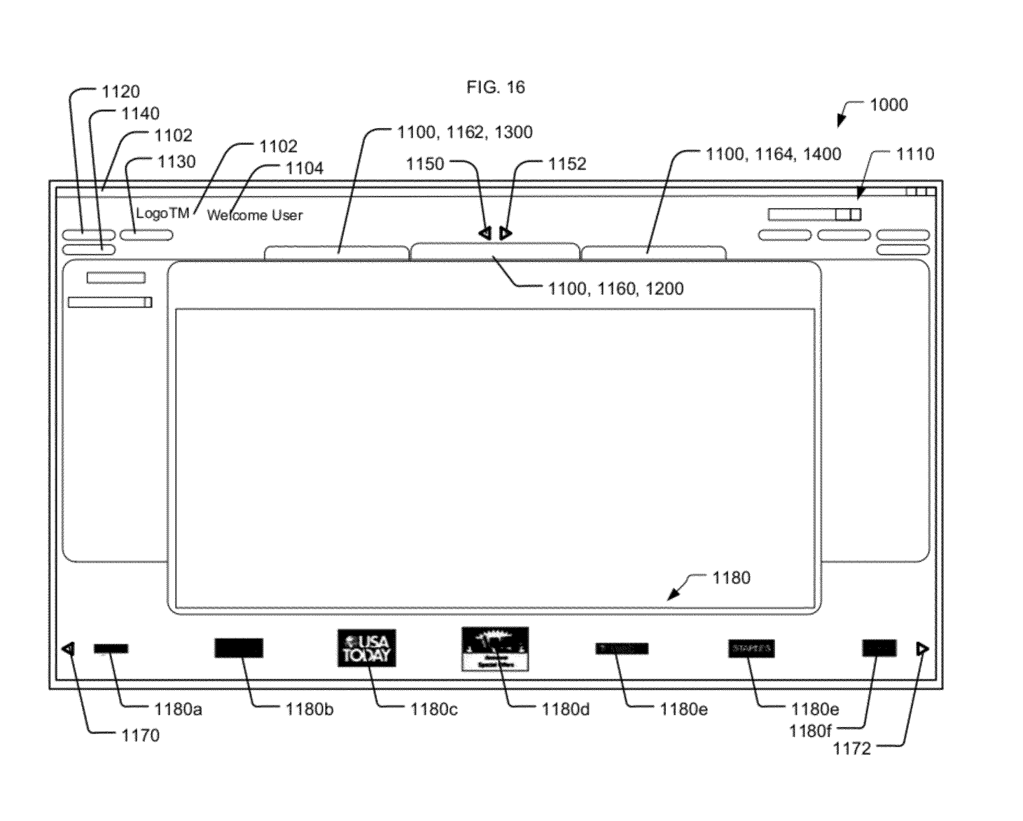

FIG. 16 is a block diagram showing an initial view of a pillar 1100 of the local portal 1000 that is arrived at once a user has been set up appropriately. Note, as a matter of design choice when no user preference has been established the local portal 1000 initially starts with a “news” view. Users are typically more receptive to news and will review what is prevented under that label, unlike shopping, which may seem too commercially forward at first impression, and unlike video, which may initially seem too technically intimidating.

Continuing, FIG. 16 includes a number features that are common to many of the views of the local portal 1000. For example, this can include branding information 1102, and FIG. 16 includes two examples (FIGS. 12-15 also include examples). This is where a party providing the local portal 1000 can establish brand recognition with the users. In the usual manner of trade and service marks, this brand reminder serves to reinforce in the mind of the user the source of the local portal 1000 and to assure them of its quality as a source of information. In the example shown in FIG. 16, the entity “Logo™” is presumed to be the manufacturer of the electronics device 14 in which the local portal 1000 has been pre-installed, rather than the source of the software that runs the local portal 1000.

The local portal 1000 can also include user confirmation information 1104, and since in this particular instance the view in FIG. 16 followed after the new user set up dialog, the local portal 1000 has automatically signed in the user based on the information from that dialog. Note however, formally signing in is not a requirement to use many features of the local portal 1000, as discussed further presently.

FIG. 16 includes most of the commonly encountered controls of the local portal 1000. The upper right area of this figure includes a number of conventional controls 1110, with functions that are so self evident that detailed further discussion should not be needed. In the upper left is a sign in/out button 1120, the account info button 1130, and a welcome button 1140. The sign in/out button 1120 leads to a sign in dialog (not shown) where a user can be selected, if more than one user has an account in the local portal 1000 at hand, and where a user can sign in. Again, signing in is not a rigid requirement. It is only necessary in this embodiment to access features where access is appropriately restricted (e.g., shopping entailing an actual purchase). If a user is already signed in, the account info button 1130 can take them directly to an account info dialog. Alternately, if no user is formally signed in, the account info button 1130 can take the user to a sign in dialog and after that to an account info dialog. The welcome button 1140 takes the local portal 1000 back to the view shown in FIG. 12.

The upper middle area of FIG. 16 includes a number of controls that are particular to controlling the pillars 1100 in the main middle area of this figure. The pillars 1100 here are a news pillar 1200, a shop pillar 1300, and a video pillar 1400. The currently active pillar is presented centermost and foremost. Here the currently active pillar 1100 is the news pillar 1200, with the shop pillar 1300 flanking behind and to the left and with the video pillar 1400 flanking behind an to the right.

This embodiment of the local portal 1000 has three mechanisms to navigate between the pillars 1100. The first mechanism is left/right triangle buttons 1150, 1152 (centered above the news pillar 1200 in the view in FIG. 16). These nominally resemble conventional scroll buttons in many graphical user interfaces. If the news pillar 1200 currently has focus, as is the case here, operating the left triangle button 1150 rotates the pillars so that the shop pillar 1300 becomes centermost and foremost, the news pillar 1200 flanks to the right and behind, and the video pillar 1400 flanks to the left and behind. Alternately, again starting with the news pillar 1200 having focus, operating the right triangle button 1152 rotates the pillars so that the video pillar 1400 becomes centermost and foremost, the news pillar 1200 flanks to the left and behind, and the shop pillar 1300 flanks to the right and behind. The second pillar navigation mechanism is news/shop/video tabs 1160, 1162, 1164. By operating a tab (e.g., with a mouse double click, a stylus, a finger tap, a finger swipe, etc.) the corresponding pillar 1100 is given the focus. And the third mechanism is to simply double click or tap in a pillar 1100 in an unambiguous manner. In the center pillar (the one foremost and currently having the focus) links are active and acting on or very close to a link there may be interpreted as selecting that link. In the left and right pillars 1100 (i.e., the ones not currently having the focus) the links are not active and acting anywhere in either of these pillars can un-ambiguously be treated as a user request to change the focus to that pillar 1100.

The lower area of FIG. 16 also includes a number of controls that are particular to the local portal 1000. At the lower left and lower right are left/right triangle buttons 1170, 1172 that rotate-ably scroll offerings in a ribbon control 1180 that has selection buttons 1180a-g. In this embodiment of the local portal 1000 the centermost selection button 1180d is reserved for a special offering from the branding party (see e.g., the discussion of the branding information 1102, above) and the offerings associated with the other selection buttons 1180a-c and 1180e-g can be scrolled through in a ribbon-like manner. For example, in FIG. 16 the selection button 1180b is shown associated with an offering from a travel service and the selection button 1180c is shown associated with an offering from a news service. If the right triangle button 1172 is operated, the offering from the news service will be moved to the selection button 1180e and the offering from the travel service will be moved to the selection button 1180c, etc.

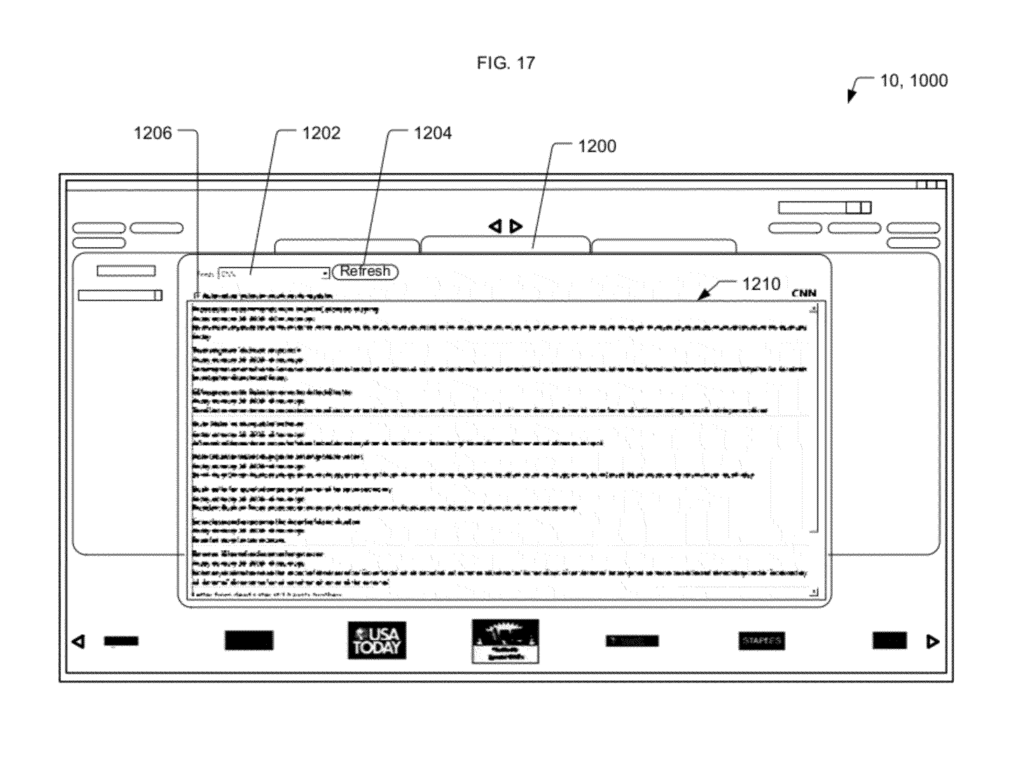

FIG. 17 is a block diagram showing an alternate view of the news pillar 1200, one subsequent to the view in FIG. 16. The news pillar 1200 itself also includes some particular controls, including a feed source drop-down list 1202, a refresh button 1204, and an auto operation check-box 1206. In FIG. 17, since the auto operation check-box 1206 is checked and the feed source drop-down list 1202 includes a valid selection, the news pillar 1200 here now contains a series of RSS news items 1210.

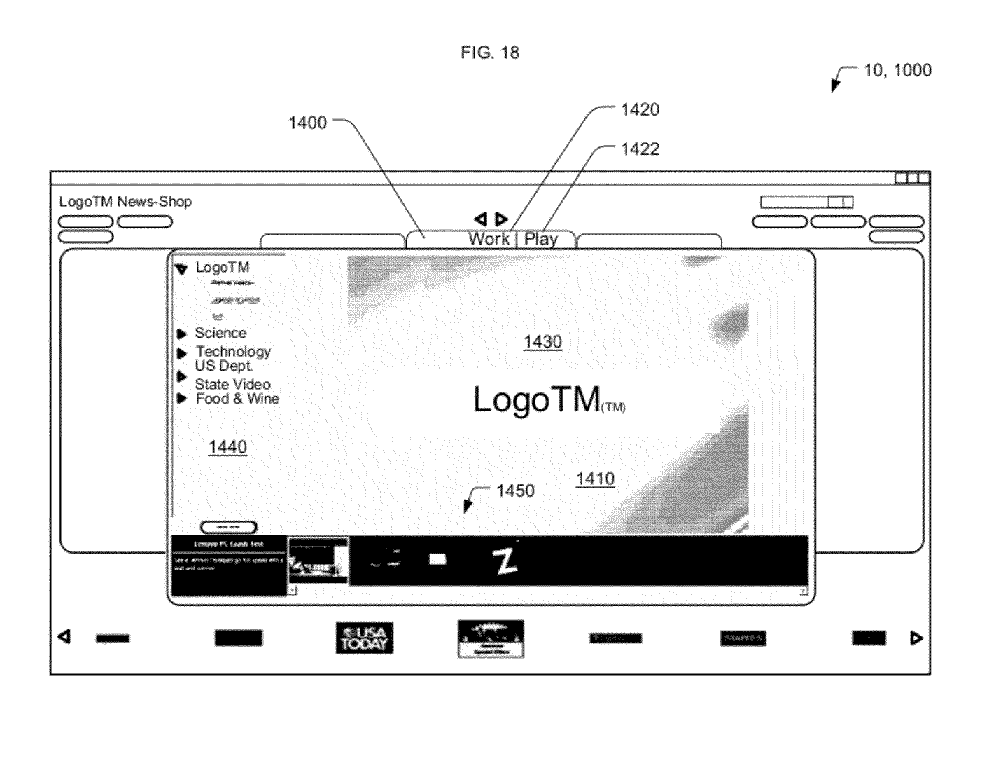

FIG. 18 is a block diagram showing the video pillar 1400 in a typical manner. The video pillar 1400 also includes some particular controls, including work/play buttons 1420, 1422. These operate as a toggle, with the currently selected mode emphasized. Video content can be categorized as work related, play related, or both (e.g., videos instructing in the use of the local portal 1000 or the electronics device 14 running it). In generally conventional manner, content is identified as such initially by where it is stored and secondarily by metadata stored in the content.

Continuing, the central feature in the video pillar 1400 is a video window 1410 where playback of videos 430 can be viewed. To the left of this is a selection control 1440 and across the bottom are thumbnail sub-regions 1450 that are selectable in button-like manner and scrollable if the quantity of possible selections merits this. As shown, each thumbnail sub-region 1450 contains a thumbnail image (or even a thumbnail size video) related to a particular selection. It should be noted that, although this pillar 1100 is termed the “video” pillar, there is no reason that it cannot also be used for slid show like presentations, audio only presentations, etc. In the latter case the video window 1430 can display a visually engaging animation or the entire local portal 1000 can be “minimized” so the user can view other material on the screen of the electronics device 14 running the local portal 1000 (e.g., to place or answer a telephone call if the electronics device 14 is a smart phone 14f; or to review a spreadsheet if the electronics device 14 is a tablet 14d). Of course, the video and audio content that is experienced using the video pillar 1400 can all be digital content as described elsewhere herein. Next we turn to how the inventive local portal 1000 can further be an extension of the inventive DCVM 10, which has already been described in detail elsewhere herein.

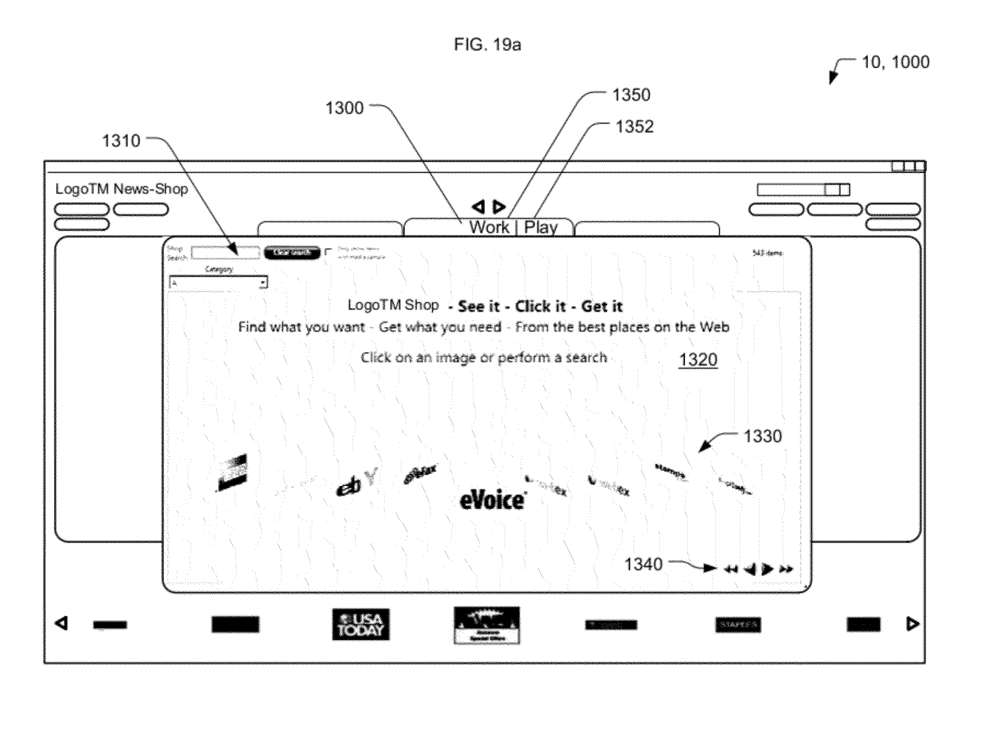

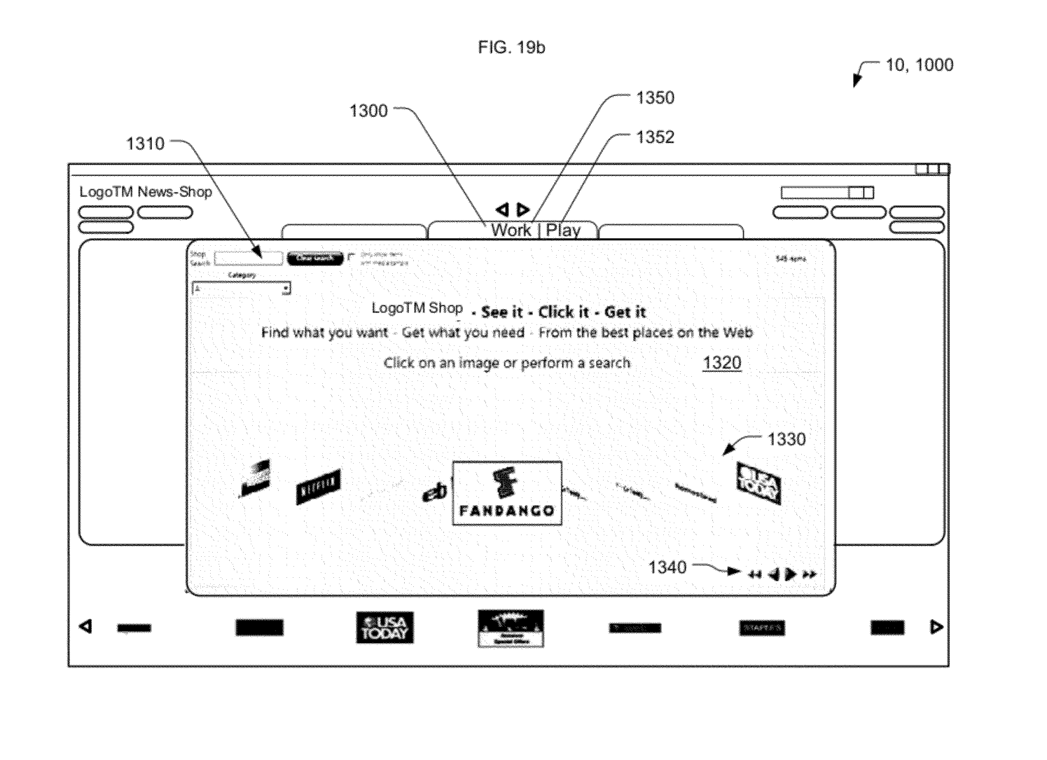

FIGS. 19a-b are block diagram showing the shop pillar 1300 in detail. As is the case for the other pillars 1100, the shop pillar 1300 also includes a number of controls that are particular to it. At the top of the shop pillar 1300 here are a set of generally straightforward search controls 1310. These are especially useful in view of the quantity of assets 22 (FIG. 1a) that will typically be present in the inventory 18 of the DCVM 10 that the local portal 1000 is part of. The results of searches in the shop pillar 1300 can be limited with the search controls 1310 to prevent too many results overwhelming the user. For example, “American” (in American Express™) can be searched for but categorized as “Financial” to avoid getting results for airline travel on American Airlines™. Below the search controls 1310 in the shop pillar 1300 is an instructions region 1320, an offerings ribbon 1330, and a set of scroll controls 1340 to control what appears in the offerings ribbon 1330. In keeping with pillar-based design metaphor of the local portal 1000 here, the offerings ribbon 1330 is navigated, displays offerings, and permits selection in a manner similar to the three main pillars 1100. The current central-most offering is emphasized by being displayed foremost and larger, while other offerings are deemphasized by being displayed rear-ward displaced and smaller. The scroll controls 1340 here also work similar to the left/right triangle buttons 1150, 1152 that control selection of a pillar 1100, only the scroll controls 1340 here include go to start and go to end functionality. Note, the normal sort order of the results presented is alphabetical, so “start” and “end” have meaning, but going to the next lower offering from the end offering can still scroll around to the starting offering.

The shop pillar 1300 also has work/play buttons 1350, 1352, and these operate as was described for the work/play buttons 1420, 1422 in the video pillar 1400. FIG. 19a depicts representative offerings in the work mode and FIG. 19b depicts representative offerings in the play mode. It should be noted that some offerings appear to be the same in both modes. This may actually be the case, or it may simply be that a vendor 42 (FIG. 2a) is configured with different offerings in each mode, and that selection of that vendor 42 in a mode will result in a different later dialog that is appropriate to the particular offering.

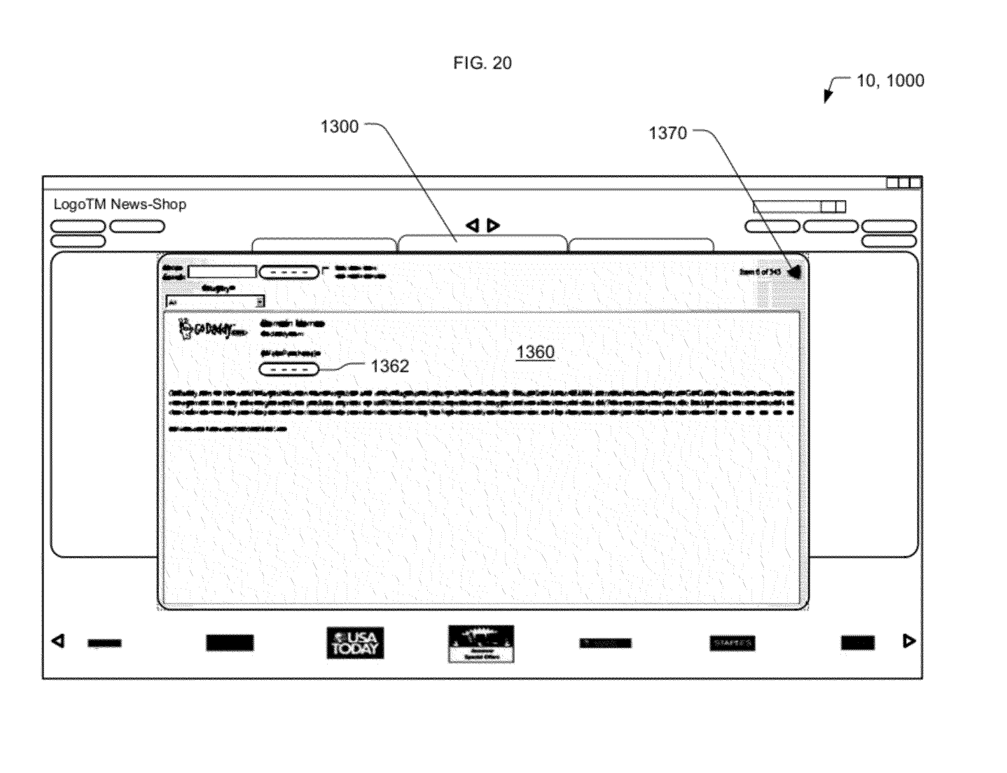

FIG. 20 is a block diagram showing the shop pillar 1300 once a user selects an offering from the offerings ribbon 1330 in FIGS. 19a-b. Selection can be accomplished by double clicking, tapping, etc. the offering anywhere in the offerings ribbon 1330 or by pressing or swiping enter when the offering is centermost in the offerings ribbon 1330. The instructions region 1320 and the offerings ribbon 1330 from FIGS. 19a-b are now replaced with an offering sub-window 1360 with its own set of particular controls, including at least one take me there button 1362. If the description of what is being offered is large, the offering sub-window 1360 can also include scroll buttons or another suitable description-navigation mechanism. When the offering sub-window 1360 is visible the shop pillar 1300 further includes a back button 1370 (and operating system, graphical user interface, and browser control conventions can also operate to take the user back to the offerings ribbon 1330 in the shop pillar 1300).

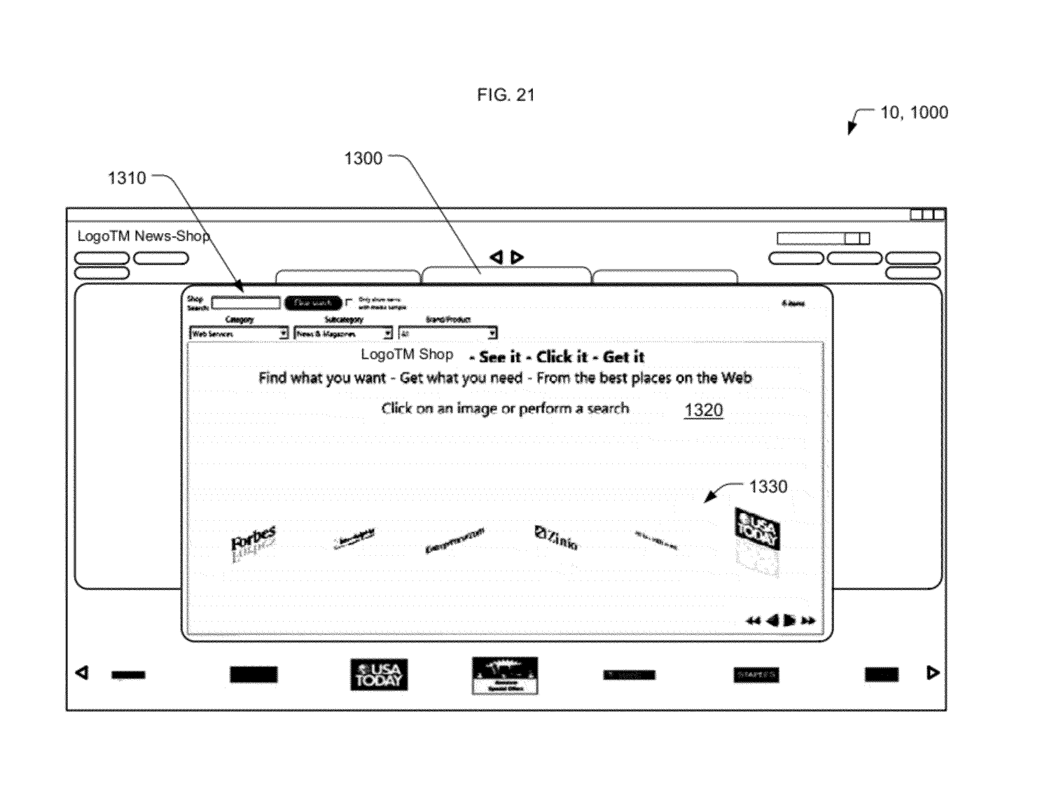

FIG. 21 is a block diagram showing the shop pillar 1300 when a large set of offerings may apply, and particularly how the search controls 1310 may dynamically increase or decrease in number and functionality to adapt to this. It should be noted that the offerings in FIG. 21 are for digital content that is non-tangible in nature, here being for subscriptions to news feed services.

While various embodiments have been described above, it should be understood that they have been presented by way of example only, and not limitation. Thus, the breadth and scope of the invention should not be limited by any of the above described exemplary embodiments, but should be defined only in accordance with the following claims and their equivalents.

### INDUSTRIAL APPLICABILITY

The present DCVM 10 is well suited for customers 40 with an electronics device 14 (e.g., PC 14a, laptop 14b, netbook 14c, tablet 14d, PDA 14e, smart phone 14f, entertainment utility device 14g, or yet other electronic device 14h) to shop at the stores 44 in the village 46 or the local portal 1000. The customers 40 can browse for “best of class” software, learn new skills, obtain the latest news or other information on topics of interest, or essentially any other manner of digital content that may be handled as assets 22. The stores 44 may provide top offerings (say, as determined by best seller lists), with some specializing in children's interests, others in adult's interests, business interests, niche genres, etc. Since top-selling (i.e., high desirability) assets 22 may be made available in the stores 44 virtually immediately, they are available at precisely the times that the customers 40 are most likely to buy—right after the asset 22 enters the market or when the customer 40 has just obtained the electronics device 14, later as impulse or need directs. There is no driving to a conventional brick-and-mortar store; the stores 44 here are open twenty-four hours a day, seven days a week, 365 days a year. Shopping in the stores 44 is friendly and hassle free (e.g., there is no sales pressure); and delivery of assets 22 from the local inventory 18 is virtually instantaneous, guaranteed, and free of delivery charges. In sum, the customers 40 may receive superior service, gain confidence in, and have access to what they want (which as described below, can be pre-loaded, and even default configured, thus largely assuring that it will work).

The present DCVM 10 is similarly well suited for the vendors 42. Traditional vendors 42 can easily set up stores 44 in the village 46 or local portal 1000 and concentrate on their product or service sales missions, leaving system management to the provider of the master server 48 and financial matters to the clearing house 50. Further, in the DCVM 10 the stores 44 can have potentially huge customer 40 traffic yet have very low operating cost. Thus, many additional and diverse potential vendors 42 may chose to operate stores 44.

The vendors 42 can also provide communications with shopkeepers, customer support, and technical support personnel in the stores 44. The DCVM 10 particularly lends itself to various marketing incentives for original equipment manufactures (OEMs), captive-brand distributors, and custom assemblers of electronics devices 14. Such system providers of electronics devices 14 can set up their own outlets and customer service centers (i.e., become vendors 42) in the village 46 shipped with the electronics devices 14 that they supply. They can also use the inherent push technology of the Internet 122 to keep these current and to promote special offers, upgrades, rebates, or software service programs. Securing a spot in the village 46 or local portal 1000 enables system providers to establish and maintain a channel of communications between themselves and their individual customers 40. Thus providers can easily enter software businesses profitably and create an annuity stream that can continue for years. To “boot strap” the customers 40 into this new manner of commerce, one store 44 can even sell Internet subscription and setup services.

The present DCVM 10 is similarly well suited for maintaining the traditional roles of the financial and governmental sectors, which are major concerns today in Internet based commerce. All transactions can be screened for fraud by the clearing houses 50, which may be operated by leading members of the financial industry. To ease commerce via licensing and to minimize disputes, or easily resolve those that do occur, the DCVM 10 may conform to the buying and license management schemes as defined by standards associations (e.g., the Software Publisher's Association), thus assuring compliance with industry standards for credit card and intellectual proprietary protection. Finally, to facilitate governmental regulatory and taxation roles, the master server 48 and the clearing house 50 are highly audit able. In fact, the DCVM 10 may be embodied to help the customers 40, vendors 42, and clearing houses 50 comply with the rules of the Financial Industry Regulatory Authority, Inc. (FINRA).

The key to the inventive DCVM 10 being able to function as described above is that it is stored in the electronics device 14 of the customer 40, thus bringing a plethora of digital content deliverable goods and services from a wide variety of vendors 42 directly to the customer 40. Accordingly, wide and rapid acceptance of the DCVM 10 can be expected.

In addition to the above mentioned examples, various other modifications and alterations of the inventive DCVM 10 may be made without departing from the invention. Accordingly, the above disclosure is not to be considered as limiting and the appended claims are to be interpreted as encompassing the true spirit and the entire scope of the invention.

What is claimed is:

1. A system for marketing digital content to a user on an electronics device, comprising:
a storage media installed in the electronics device;
said storage media containing an inventory of assets that are instances of the digital content and which are each protected from unauthorized use by a digital wrapper;
a logic in the electronics device to:
display information about said inventory to the user;
accept a selection by the user of a particular said asset;
transmit a payment for said selection and an identifier associated with said selection to a clearing house;
receive a first key from said clearing house;
transmit said first key to a master server;
receive a second key from said master server; and
with said second key unwrap said digital wrapper protecting said selection.

2. The system of claim 1, wherein said storage media is installed by a manufacturer of the personal computer with said inventory already pre-stored therein.

3. The system of claim 1, wherein said storage media is installed as part of an upgrade of the personal computer with said inventory already pre-stored therein.

4. The system of claim 1, wherein said storage media is a fixed media.

5. The system of claim 1, wherein said storage media is a primary media.

6. The system of claim 1, wherein said particular said asset is an executable software that is pre-configured to run from said storage media once unwrapped.

7. The system of claim 1, wherein:
the electronics device has a substantially unique indicia; and
said second key is coded to work only with said unique indicia, thereby preventing said second key from being usable to unwrap a same said asset present on a different device.

8. A unit for use in marketing digital content to a user of an electronics device, comprising:
a storage media for installation in the electronics device, wherein:
an inventory of assets are stored in said storage media;
said assets are instances of the digital content; and
said assets are protected from unauthorized use by a digital wrapper; and wherein
said storage media includes a client logic that is installable into the electronics device to:
display information about said inventory to the user;
accept a selection by the user of a particular said asset;
transmit a payment for said selection and an identifier associated with said selection to a clearing house;
receive a first key from said clearing house;
transmit said first key to a master server;
receive a second key from said master server; and
with said second key unwrap said digital wrapper protecting said selection.

9. The unit of claim 8, wherein said storage media is a fixed media.

10. The unit of claim 8, wherein said storage media is a primary media.

11. The unit of claim 8, wherein said client logic operates a managed client that is perceivable by the user as a local portal.

12. The unit of claim 8, wherein said particular said asset is an executable software that is pre-configured to run from said storage media once unwrapped.

13. The unit of claim 8, wherein:
the electronics device has a substantially unique indicia; and
said second key is coded to work only with said unique indicia, thereby preventing said second key from being usable to unwrap a same said asset present on a different device.

14. A method for marketing digital content on an electronics device, comprising:
(a) storing an inventory of assets in a storage media in the electronics device prior to its delivery to a user, wherein said assets are instances of the digital content and are protected from unauthorized use by a digital wrapper;
(b) displaying information about said inventory to said user;
(c) accepting a selection representing a particular said asset from said user;
(d) transmitting a payment for said selection and an identifier associated with said selection to a clearing house, via a communications system;
(e) receiving a first key from said clearing house;
(f) transmitting said first said key to a master server, via said communications system;
(g) receiving a second key from said master server; and
(h) unwrapping said digital wrapper protecting said selection using said second key.

15. The method of claim 14, wherein said storage media is a fixed media.

16. The method of claim 15, wherein said storage media is a primary media.

17. The method of claim 16, wherein said (b) includes operating a managed client that is perceivable by the user as a local portal.

18. The method of claim 16, wherein said particular said asset is an executable software that is pre-configured to run from said storage media once unwrapped.

19. The method of claim 16, wherein:
the electronics device has a substantially unique indicia; and
said second key is coded to work only with said unique indicia, thereby preventing said second key from being usable to unwrap a same said asset present on a different device.

20. A system for marketing digital content in an electronics device, comprising:
storage means for storing an inventory of assets which are instances of the digital content, wherein each said asset is protected from unauthorized use by a digital wrapper, and wherein said inventory is stored in the electronics device prior to its delivery to a user;
display means for displaying information to said user of the electronics device;
input means to accept input from said user;
communications means for communicating with remote computer systems on a network; and
client means for:
controlling said display means to display information about said inventory to said user,
controlling said input means to accept from said user a selection representing a particular said asset,
controlling said communications means to transmit a payment for said selection and an identifier associated with said selection to a clearing house, receive a first key from said clearing house, transmit said first key to a master server, receive a second key from said master server, and
unwrapping said digital wrapper with said second key.
